(19) United States
(12) Patent Application Publication
(10) Pub. No.: US 2020/0162756 A1
(43) Pub. Date: May 21, 2020

(54) IMAGE PROCESSING DEVICE AND METHOD, AND PROGRAM

(71) Applicant: SONY SEMICONDUCTOR SOLUTIONS CORPORATION, Kanagawa (JP)

(72) Inventors: Sinsuke HISHINUMA, Tokyo (JP); Jongdae KIM, Tokyo (JP); Masao SASAKI, Kanagawa (JP)

(73) Assignee: SONY SEMICONDUCTOR SOLUTIONS CORPORATION, Kanagawa (JP)

(21) Appl. No.: 16/604,821

(22) PCT Filed: May 10, 2018
(86) PCT No.: PCT/JP2018/018041

§ 371 Date: Oct. 11, 2019

(30) Foreign Application Priority Data
May 24, 2017 (JP) 2017-102663

(51) Int. Cl. H04N 19/593; H04N 19/105; H04N 19/11; H04N 19/176

(52) U.S. Cl. CPC H04N 19/593; H04N 19/176; H04N 19/11; H04N 19/105

(57) ABSTRACT

There is provided an image processing device, an image processing method, and a program for enabling obtainment of a prediction pixel in an easier and more prompt manner a lower cost. The image processing device includes a prediction unit configured to generate, in a case of generating a prediction pixel of a current block of an image to be processed by intra prediction, in a case where a pixel in a previous block previous to the current block in a processing order is an adjacent pixel to be used for generating the prediction pixel, the prediction pixel using a pixel value of another adjacent pixel in another block different from the previous block as a pixel value of the adjacent pixel in the previous block. The present technology can be applied to an encoding device and a decoding device.

### TECHNICAL FIELD

The present technology relates to an image processing device, an image processing method, and a program, and particularly to an image processing device, a method, and a program for enabling obtainment of a prediction pixel in an easier and more prompt manner at a lower cost.

### BACKGROUND ART

Intra prediction is a useful technology used in moving image compression and is also adopted in international standards such as advanced video coding (AVC) and high efficiency video coding (HEVC).

In intra prediction, a prediction pixel is generated in units of orthogonal transform blocks but the prediction pixel needs to be generated with reference to a pixel of a previously processed intra prediction block, depending on a reference direction.

When attempting to generate the prediction pixel using a pixel of an adjacent block in a processing order as described above, intra prediction processing of a current block to be processed cannot be started until completion of local decoding of the adjacent block.

In particular, in an encoding device (encoder), parallelization of processing and pipeline processing become difficult, and showing performance is costly. In other words, to improve a processing speed at the time of intra prediction, a clock frequency needs to be increased and the number of parallel processes needs to be increased, which increases the cost in hardware.

Although not so much as the encoding device, in a decoding device (decoder), reference to a pixel of an adjacent block at the time of intra prediction is a cause for an increase in cost.

In intra prediction of future video coding (FVC) for which standardization is currently considered, similar inconvenience to the above-described AVC and HEVC is expected to occur.

Furthermore, as a technology related to intra prediction, a technology of changing a processing order of blocks and an adjacent pixel to be referred to at the time of intra prediction to decrease reference to a pixel of a block processed immediately before a current block is proposed (for example, see Patent Document 1).

### CITATION LIST

### Patent Document

### Patent Document 1: Japanese Patent Application Laid-Open No. 2004-140473

### SUMMARY OF THE INVENTION

### Problems to be Solved by the Invention

However, with the above-described technology, easily and promptly obtaining a prediction pixel at a low cost has been difficult.

For example, in the technology described in Patent Document 1, since the processing order of blocks is changed at the time of intra prediction, not only processing becomes complicated but also the adjacent pixel to be referred to needs to be changed and thus an operation (a calculation formula for derivation) at the time of generating a prediction pixel also changes and implementation becomes complicated.

The present technology has been made in view of the foregoing, and enables obtainment of a prediction pixel in an easier and more prompt manner at a lower cost.

### Solutions to Problems

An image processing device according to one aspect of the present technology includes: a prediction unit configured to generate, in a case of generating a prediction pixel of a current block of an image to be processed by intra prediction, in a case where a pixel in a previous block previous to the current block in a processing order is an adjacent pixel to be used for generating the prediction pixel, the prediction pixel using a pixel value of another adjacent pixel in another block different from the previous block as a pixel value of the adjacent pixel in the previous block.

An image processing method or a program according to one aspect of the present technology includes a step of: generating, in a case of generating a prediction pixel of a current block of an image to be processed by intra prediction, in a case where a pixel in a previous block previous to the current block in a processing order is an adjacent pixel to be used for generating the prediction pixel, the prediction pixel using a pixel value of another adjacent pixel in another block different from the previous block as a pixel value of the adjacent pixel in the previous block.

In one aspect of the present technology, in a case of generating a prediction pixel of a current block of an image to be processed by intra prediction, in a case where a pixel in a previous block previous to the current block in a processing order is an adjacent pixel to be used for generating the prediction pixel, the prediction pixel is generated using a pixel value of another adjacent pixel in another block different from the previous block as a pixel value of the adjacent pixel in the previous block.

### Effects of the Invention

According to one aspect of the present technology, a prediction pixel can be more easily and promptly obtained at a lower cost.

Note that the effects described here are not necessarily limited, and any of effects described in the present disclosure may be exhibited.

### BRIEF DESCRIPTION OF DRAWINGS

FIG. 1 is a diagram for describing intra prediction and occurrence of a stall.

FIG. 2 is a diagram for describing intra prediction and occurrence of a stall.

FIG. 3 is a diagram for describing intra prediction and occurrence of a stall.

FIG. 4 is a diagram for describing intra prediction and occurrence of a stall.

FIG. 5 is a diagram for describing intra prediction and occurrence of a stall.

FIG. 6 is a diagram for describing intra prediction to which the present technology is applied.

FIG. 7 is a diagram for describing intra prediction to which the present technology is applied.

FIG. 8 is a diagram for describing intra prediction to which the present technology is applied.

FIG. 9 is a diagram for describing intra prediction to which the present technology is applied.

FIG. 10 is a diagram illustrating a configuration example of an image encoding device.

FIG. 11 is a flowchart for describing image encoding processing.

FIG. 12 is a flowchart illustrating intra prediction processing.

FIG. 13 is a diagram illustrating a configuration example of an image decoding device.

FIG. 14 is a flowchart for describing image decoding processing.

FIG. 15 is a flowchart illustrating intra prediction processing.

FIG. 16 is a diagram for describing application conditions of substitute intra prediction.

FIG. 17 is a diagram for describing application conditions of substitute intra prediction.

FIG. 18 is a flowchart for describing image encoding processing.

FIG. 19 is a flowchart illustrating intra prediction processing.

FIG. 20 is a flowchart illustrating intra prediction processing.

FIG. 21 is a diagram for describing application conditions of substitute intra prediction.

FIG. 22 is a diagram for describing application of substitute intra prediction.

FIG. 23 is a diagram for describing application conditions of substitute intra prediction.

FIG. 24 is a diagram for describing application of substitute intra prediction.

FIG. 25 is a diagram for describing restrictions at the time of determining a level value.

FIG. 26 is a diagram illustrating a configuration example of a computer.

### MODE FOR CARRYING OUT THE INVENTION

Hereinafter, embodiments to which the present technology is applied will be described with reference to the drawings.

### First Embodiment

### <Intra Prediction>

The present technology enables, in intra prediction, obtainment of a prediction pixel in an easier and more prompt manner at a lower cost by using a pixel value of another pixel as a pixel value of an adjacent pixel to be referred to when using a pixel of a block (hereinafter also referred to as previous block) processed immediately before a current block to be processed as the adjacent pixel in predicting a pixel of the current block.

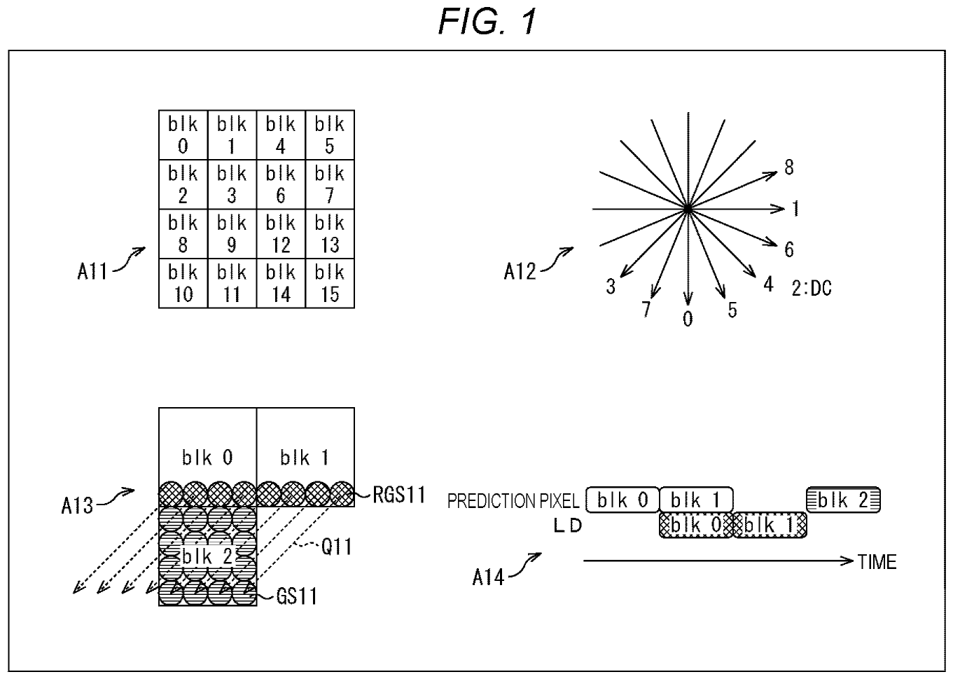

First, an outline of intra prediction and the present technology will be described with reference to FIGS. 1 to 9. Note that, in FIGS. 1 to 9, description of mutually corresponding parts is appropriately omitted to avoid redundant description.

For example, in AVC, assuming that a macroblock is divided into sixteen blocks blk0 to blk15, as illustrated with the arrow A11 in FIG. 1, and intra prediction is performed for these blocks. Here, the sixteen blocks are blocks of 4 pixels×4 pixels, and the pixels of each block are predicted from the blocks blk0 to blk15 in order of the blocks blk0 to blk15, and a prediction image is generated. Note that the processing order of these blocks is predetermined.

Furthermore, in AVC, a prediction direction (reference direction) in each intra prediction mode is predetermined as illustrated with the arrow A12.

Note that, in the portion illustrated with the arrow A12, each arrow indicates the prediction direction in the intra prediction mode, and the number described in the portion of the arrow indicates the intra prediction mode, that is, an intra prediction mode number. Hereinafter, the intra prediction mode with the mode number of A (where A is an integer) is described as intra prediction mode A. Here, an intra prediction mode 2 is a direct current (DC) mode.

Now, consider a case in which each pixel in the block blk2 is predicted by an intra prediction mode 3 as illustrated with the arrow A13, for example.

In the portion illustrated with the arrow A13, each quadrangle represents a block in the macroblock, and a circle in the block represents a pixel.

Furthermore, a dotted arrow drawn from each pixel as a starting point such as the arrow Q11 indicates the prediction direction in the intra prediction mode 3.

At the time of intra prediction, a pixel of another block in an opposite direction to the prediction direction with respect to a pixel in the block blk2 as a current block is used for prediction of a pixel in the block blk2. In other words, a pixel of another block in an opposite direction to the prediction direction with respect to a pixel in the block blk2 is used as an adjacent pixel. In particular, here, hatched pixels in the blocks blk0 and blk1 are the adjacent pixels.

In this example, for example, a pixel RGS11 in the block blk1 is located in the opposite direction to the prediction direction illustrated with the arrow Q11 with respect to a pixel GS11 in the block blk2, and this pixel RGS11 is regarded as the adjacent pixel and is used for prediction of a pixel value of the pixel GS11 as a prediction pixel. Note that, more specifically, in prediction of the pixel value of the pixel GS11, prediction of the pixel value is performed by filter processing using not only the pixel RGS11 but also the pixel adjacent on the left side of the pixel RGS11 in FIG. 1.

In the case of predicting the pixels in the block blk2 by the intra prediction mode 3 as described above, the pixels in the blocks blk0 and blk1 adjacent to the block blk2 and located earlier in the processing order than the block blk2 are the adjacent pixels used for prediction.

Here, the processing order of the block blk1 is a previous order to the block blk2, and the block blk1 is a previous block with respect to the block blk2.

Therefore, to use the pixels of the block blk1 as the adjacent pixels, local decoding of the block blk1 needs to be completed at timing when intra prediction of the block blk2 is performed, as illustrated with the arrow A14.

Note that, in the portion illustrated with the arrow A14, the horizontal direction indicates time, and each quadrangle represents a block. In particular, in the portion illustrated with the arrow A14, the quadrangle drawn on the upper side in FIG. 1 represents the timing of performing intra prediction of each block, and the quadrangle drawn on the lower side in FIG. 1 represents the timing of local decoding of each block.

In this example, local decoding of the block blk0 is performed at the timing when intra prediction of the block blk1 is performed, and local decoding of the next block blk1 is performed after the local decoding of the block blk0 is completed.

Therefore, at the timing when the intra prediction of the block blk1 is completed, the local decoding of the block blk1 has not been performed yet. Therefore, while the local decoding of the block blk1 is being performed, intra prediction of the next block blk2 cannot be performed and a stall state occurs, and the intra prediction of the block blk2 is started at the timing when the local decoding of the block blk1 is completed. That is, in this example, in the pipeline processing, until the local decoding of the block blk1 is completed after the intra prediction of the block blk1 is completed, the processing needs to stand by without starting the intra prediction of the block blk2.

Therefore, to more promptly perform intra prediction of each block in the macroblock to obtain a prediction image, measures such as increasing a clock frequency of a processing block (processing circuit) are required, which increases the cost.

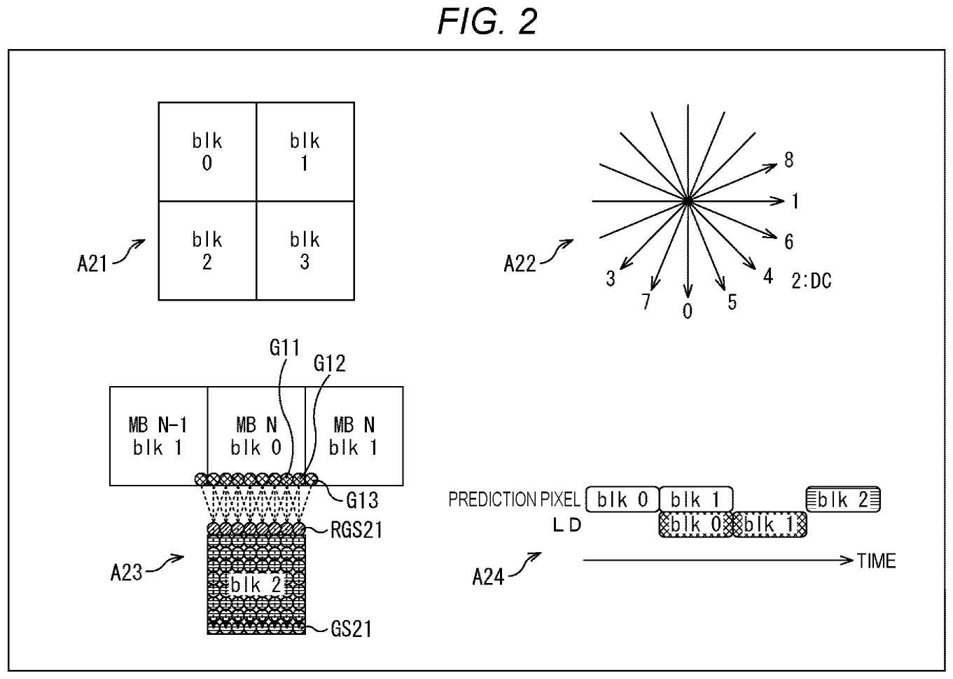

Similarly, in AVC, assuming that a macroblock is divided into four blocks blk0 to blk3, as illustrated with the arrow A21 in FIG. 2, and intra prediction is performed. Here, the four blocks are blocks of 8 pixels×8 pixels, and the pixels are processed from the blocks blk0 to blk3 in order, and a prediction image is generated. Note that the processing order of these blocks is predetermined.

Furthermore, in AVC, the prediction direction in each intra prediction mode is predetermined as illustrated with the arrow A22.

Now, consider a case in which each pixel in the block blk2 is predicted by an intra prediction mode 0 as illustrated with the arrow A23, for example.

Note that, here, the quadrangle in which the character “MB N−1 blk1” is written represents a block blk1 (hereinafter also referred to as previous block blk1) in a macroblock adjacent to the macroblock including the block blk2 that is a current block to be processed and processed immediately before the macroblock including the block blk2. Furthermore, the quadrangles in which the characters “MB N blk0” and “MB N blk1” are written respectively represent the block blk0 and the block blk1 in the macroblock including the block blk2 as the current block.

In this example, the pixels in the three blocks of the previous block blk1, the block blk0, and the block blk1 adjacent to the block blk2 are used as adjacent pixels, and prediction of the pixels in the block blk2 is performed. In particular, here, hatched pixels in the previous block blk1, the block blk0, and the block blk1 are the adjacent pixels.

For example, in prediction of a pixel GS21 in the block blk2, a pixel RGS21 of another block in the opposite direction to the prediction direction with respect to the pixel GS21 is used as the adjacent pixel.

In this case, the pixel RGS21 that is a final adjacent pixel is generated by filter processing using pixels G11 and G12 that are adjacent pixels in the block blk0 and a pixel G13 that is an adjacent pixel in the block blk1. This pixel RGS21 corresponds to the pixel GS12.

In the case of predicting the pixels in the block blk2 by the intra prediction mode 0 as described above, the pixels in the previous block blk1, the block blk0, and the block blk1 adjacent to the block blk2 and located earlier in the processing order than the block blk2 are the adjacent pixels.

Here, the processing order of the block blk1 is previous to the block blk2, and the block blk1 is a previous block with respect to the block blk2.

Therefore, as in the example in FIG. 1, until local decoding of the block blk1 is completed after intra prediction of the block blk1 is completed, intra prediction of the block blk2 cannot be started and the stall state occurs, as illustrated with the arrow A24.

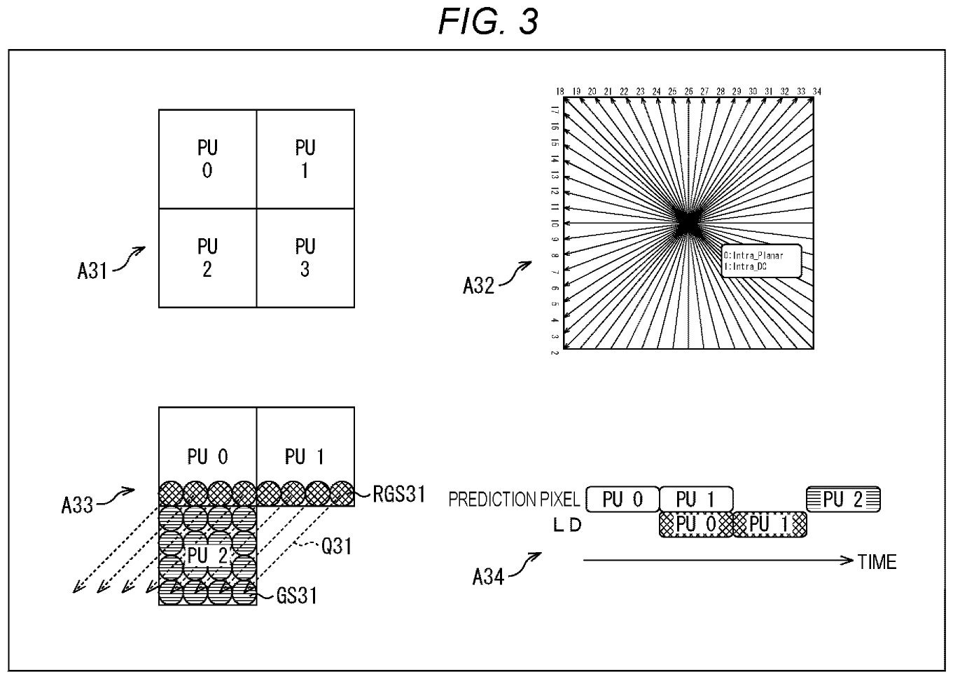

Furthermore, in HEVC, assuming that a coding unit (CU) of 8 pixels×8 pixels is divided into four prediction units PU0 to PU3, as illustrated with the arrow A31 in FIG. 3, and intra prediction is performed. Here, the four PUs are blocks of 4 pixels×4 pixels, and the pixels are processed from the PU0 to PU3 in order, and a prediction image is generated. Note that the processing order of these PUs is predetermined.

In HEVC, the reference direction in each intra prediction mode is predetermined as illustrated with the arrow A32.

Now, consider a case in which each pixel in the PU2 is predicted by an intra prediction mode 34 as illustrated with the arrow A33, for example.

At the time of intra prediction, a pixel of another PU in the reference direction with respect to a pixel in the PU2 that is a current block is used for prediction of the pixel of the PU2. In other words, a pixel of another PU in the reference direction with respect to a pixel in the PU2 is used as an adjacent pixel. Here, the hatched pixels in PU0 and PU1 are the adjacent pixels.

In this example, the dotted arrow illustrated with the arrow Q31 indicates the opposite direction to the reference direction of the intra prediction mode 34. For example, a pixel RGS31 in the PU1 is located in the reference direction with respect to a pixel GS31 in the PU2, and this pixel RGS31 is regarded as the adjacent pixel and is used for prediction of a pixel value of the pixel GS31.

In the case of predicting the pixels in the PU2 by the intra prediction mode 34, the pixels in the PU0 and PU1 adjacent to the PU2 and located earlier in the processing order than the PU2 are the adjacent pixels.

Here, the processing order of the PU1 is previous to the PU2, and the PU1 is a previous block with respect to the PU2. Therefore, as in the example in FIG. 1, until local decoding of the PU1 is completed after intra prediction of the PU1 is completed, intra prediction of the PU2 cannot be started and the stall state occurs, as illustrated with the arrow A34.

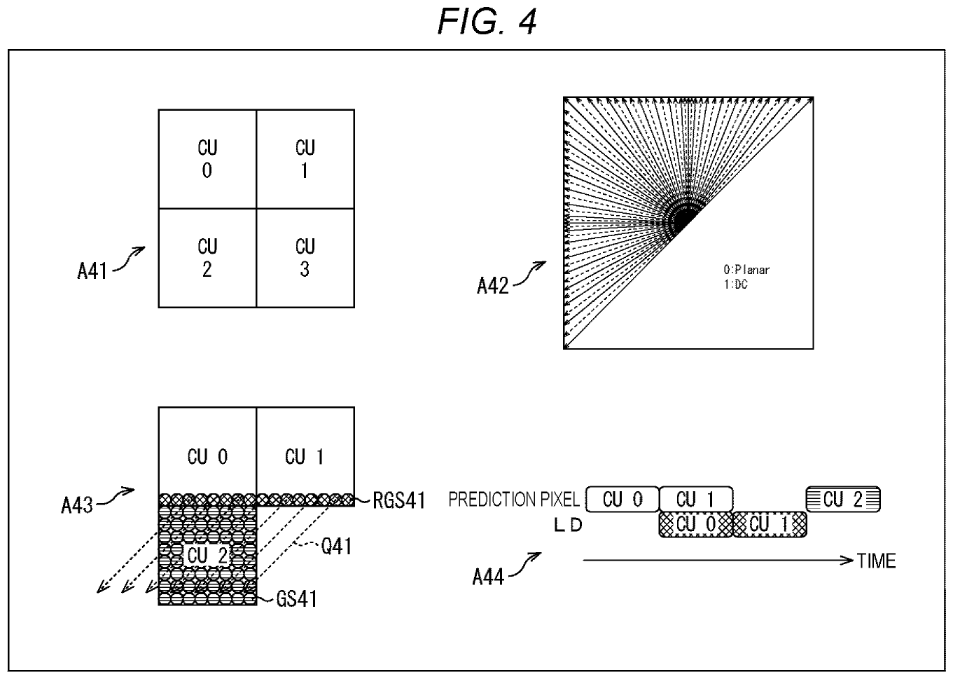

Moreover, in FVC (joint exploration test model (JEM) 4) based on HEVC, assuming that a picture is divided into CUs of 8 pixels×8 pixels by quadtree plus binary tree (QTBT) as illustrated with the arrow A41 in FIG. 4, and intra prediction is performed. Note that, in QTBT, CU=PU=TU (Transform Unit).

Here, four CU0 to CU3 are illustrated as mutually adjacent CUs, and these CUs are processed in order from the CU0 to CU3, and a prediction image is generated. Note that the processing order of these CUs is predetermined.

In FVC, the reference direction in each intra prediction mode is predetermined as illustrated with the arrow A42. Note that the intra prediction mode 0 is a planar mode, and an intra prediction mode 1 is a DC mode.

Now, consider a case in which each pixel in the CU2 is predicted by an intra prediction mode 66 as illustrated with the arrow A43, for example.

At the time of intra prediction, a pixel of another CU in the reference direction with respect to a pixel in the CU2 that is a current block is used for prediction of the pixel of the CU2. In other words, a pixel of another CU in the reference direction with respect to a pixel in the CU2 is used as an adjacent pixel. Here, the hatched pixels in CU0 and CU1 are the adjacent pixels.

In this example, the dotted arrow illustrated with the arrow Q41 indicates the opposite direction to the reference direction of the intra prediction mode 66. For example, a pixel RGS41 in the CU1 is located in the reference direction with respect to a pixel GS41 in the CU2, and this pixel RGS41 is regarded as the adjacent pixel and is used for prediction of a pixel value of the pixel GS41.

In the case of predicting the pixels in the CU2 by the intra prediction mode 66, the pixels in the CU0 and CU1 adjacent to the CU2 and located earlier in the processing order than the CU2 are the adjacent pixels.

Here, the processing order of the CU1 is previous to the CU2, and the CU1 is a previous block with respect to the CU2. Therefore, as in the example in FIG. 1, until local decoding of the CU1 is completed after intra prediction of the CU1 is completed, intra prediction of the CU2 cannot be started and the stall state occurs, as illustrated with the arrow A44.

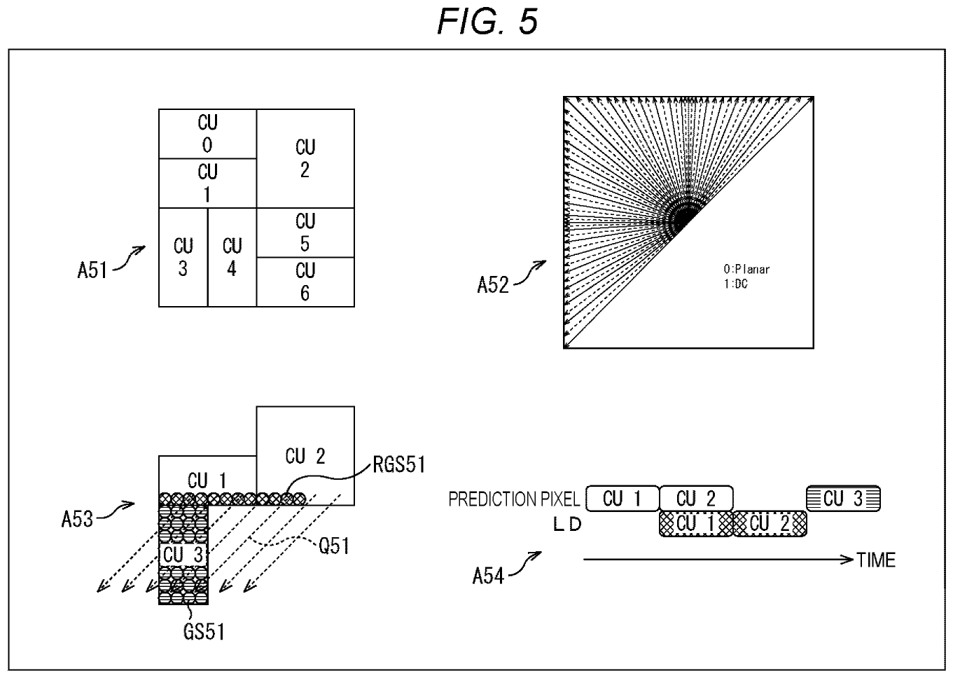

Similarly, in FVC (JEM4), assuming that a part of a picture is divided into seven CU0 to CU6 by QTBT as illustrated with the arrow A51 in FIG. 5, for example, and intra prediction is performed.

Here, the CU0, CU1, CU5, and CU6 are blocks of 8 pixels×4 pixels (CUs), the CU2 is a block of 8 pixels×8 pixels, and the CU3 and CU4 are blocks of 4 pixels×8 pixels.

These adjacent CUs are processed in order from the CU0 to CU6, and a prediction image is generated. Note that the processing order of these CUs is predetermined.

In FVC, the reference direction in each intra prediction mode is predetermined as illustrated with the arrow A52.

Now, consider a case in which each pixel in the CU3 of 4 pixels×8 pixels is predicted by the intra prediction mode 66 as illustrated with the arrow A53, for example.

At the time of intra prediction, a pixel of another CU in the reference direction with respect to a pixel in the CU3 that is a current block is used for prediction of the pixel of the CU3. In other words, a pixel of another CU in the reference direction with respect to a pixel in the CU3 is used as an adjacent pixel. Here, the hatched pixels in CU1 and CU2 are the adjacent pixels.

In this example, the dotted arrow illustrated with the arrow Q51 indicates the opposite direction to the reference direction of the intra prediction mode 66. For example, a pixel RGS51 in the CU2 is located in the reference direction with respect to a pixel GS51 in the CU3, and this pixel RGS51 is regarded as the adjacent pixel and is used for prediction of a pixel value of the pixel GS51.

In the case of predicting the pixels in the CU3 by the intra prediction mode 66, the pixels in the CU1 and CU2 adjacent to the CU3 and located earlier in the processing order than the CU3 are the adjacent pixels.

Here, the processing order of the CU2 is previous to the CU3, and the CU2 is a previous block with respect to the CU3. Therefore, as in the example in FIG. 1, until local decoding of the CU2 is completed after intra prediction of the CU2 is completed, intra prediction of the CU3 cannot be started and the stall state occurs, as illustrated with the arrow A54.

In the case of performing intra prediction by the pipeline processing in AVC, HEVC, or FVC, as described above, a stall occurs when using a pixel of a block processed immediately before the current block as the adjacent pixel in predicting a pixel in the current block.

In other words, in performing the intra prediction, reference to the pixel in the previous block as the adjacent pixel in the prediction of the current block causes an impediment to prompt execution of the pipeline processing and parallel processing of the intra prediction.

Therefore, to improve the processing speed, the clock frequency needs to be further increased, which increases the cost.

Furthermore, a technology of changing the processing order of blocks and an adjacent pixel to be referred to at the time of intra prediction to decrease the reference to the pixel of the block processed immediately before the current block is conceivable but the processing becomes complicated.

Therefore, in the present technology, as a pixel value of the adjacent pixel in the previous block, a pixel value of an adjacent pixel in another block adjacent to the previous block is used.

In other words, in the case of generating a prediction pixel of a current block of an image to be processed such as an image to be encoded or an image to be decoded by intra prediction, when using a pixel in a previous block in a predetermined processing order immediately before the current block as an adjacent pixel, a pixel value of an adjacent pixel in another different block adjacent to the previous block is used as a pixel value of the adjacent pixel in the previous block. In this case, the pixel value of the adjacent pixel adjacent to the previous block is used as the pixel value of the adjacent pixel in the previous block.

Thereby, the need to refer to the adjacent pixel of the previous block is substantially eliminated. Occurrence of a stall described with reference to FIGS. 1 to 5 can be prevented, and a prediction pixel can be more easily and promptly obtained at a lower cost.

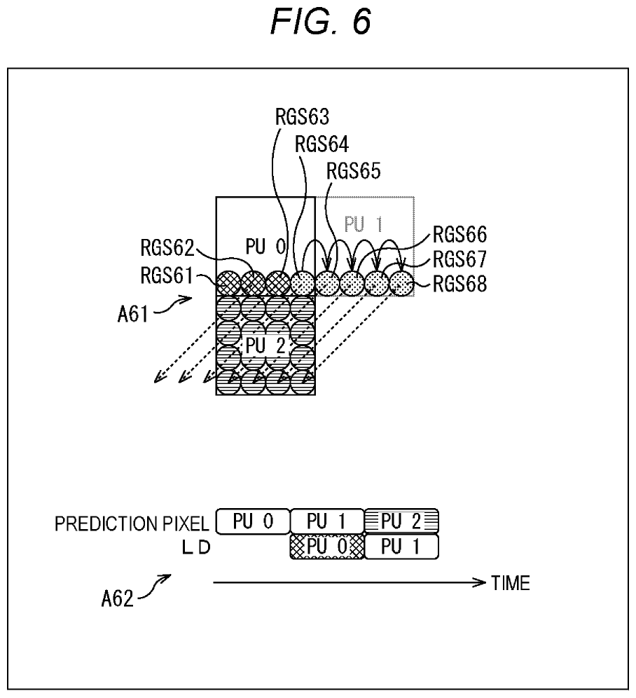

Specifically, in the case of performing intra prediction in HEVC, for example, assuming that pixels in PU2 are predicted by an intra prediction mode 34, as illustrated with the arrow A61 in FIG. 6.

In the example illustrated with the arrow A61, PU0 and PU1 exist at positions adjacent to the PU2, and intra prediction processing is performed in order of the PU0, PU1, and PU2. Note that the processing order of these PUs is predetermined. Furthermore, the arrows in FIG. 6 represent the opposite direction to the reference direction in the intra prediction mode 34.

In this example, in the intra prediction of the PU2, pixels RGS61 to RGS64 located in the PU0 and adjacent to the PU2 and pixels RGS65 to RGS68 located in the PU1 and in the vicinity of the PU2 are used as the adjacent pixels.

Since the pixels RGS61 to RGS68 used as the adjacent pixels are pixels in the PU0 and PU1 in the processing order earlier than the PU2, these pixels RGS61 to RGS68 are originally referable in the intra prediction in HEVC.

However, in the present technology, although the pixels RGS65 to RGS68 in the PU1 processed immediately before the PU2 to be processed are used as adjacent pixels, the pixel value of the pixel RGS64 that is another adjacent pixel adjacent to the PU1 is used as the pixel values of the pixels RGS65 to RGS68.

In other words, the pixel value of the pixel RGS64 is copied and the copied pixel value is used as the pixel values of the pixels RGS65 to the pixel RGS68. In other words, the pixel values of the pixels RGS65 to RGS68 are substituted by the pixel value of the pixel RGS64. Note that pixel positions of the pixels RGS65 to RGS68 that are the adjacent pixels are used as they are for prediction.

By doing so, the pixels RGS65 to RGS68 in the PU1 processed immediately before the PU2 are not substantially referred to as the pixel positions of the adjacent pixels although the pixels are used as they are. Therefore, the intra prediction of the PU2 can be immediately started without waiting for completion of local decoding of the PU1.

In other words, the intra prediction of the PU2 can be performed immediately after completion of the intra prediction of the PU0 and PU1, as illustrated with the arrow A62.

In the portion illustrated with the arrow A62, the horizontal direction indicates time, and each quadrangle represents a PU (block). In particular, in the portion illustrated with the arrow A62, the quadrangle drawn on the upper side in FIG. 6 represents the timing of performing intra prediction of each PU, and the quadrangle drawn on the lower side in FIG. 6 represents the timing of local decoding of each PU.

In this example, the local decoding of the PU0 is performed at the timing when the intra prediction of the PU1 is performed, the intra prediction of the PU2 can be performed immediately after completion of the intra prediction of the PU1 if the local decoding of the PU0 has been completed.

This is because, in the intra prediction of the PU2, there is no need to refer to the pixel value of the pixel in the PU1, as described above, and thus the intra prediction of the PU2 can be started even if the local decoding of the PU1 is not completed.

In the example described with reference to FIG. 3, the intra prediction of the PU2 cannot be started and pending (stall) occurs until completion of the local decoding of the PU1. In contrast, in the example in FIG. 6, the pixel values of the adjacent pixels of the PU1 are substituted by the pixel value of the adjacent pixel of the PU0, whereby the intra prediction of the PU2 can be performed without waiting for the completion of the local decoding of the PU1 and without stalling the pipeline processing. Thereby, a prediction pixel becomes able to be more easily and promptly obtained at a lower cost.

In this case, in particular, the PUs can be processed in the order predetermined by HEVC without changing the order of processing of the PU0 to PU2. Furthermore, the pixel values are substituted while using the pixel positions of the adjacent pixels in the previously processed PU1 as they are at the time of intra prediction of the PU2, whereby prediction of pixels can be performed by the operation (calculation formula for pixel value derivation) predetermined in HEVC without substantially referring to the pixel values of the adjacent pixels.

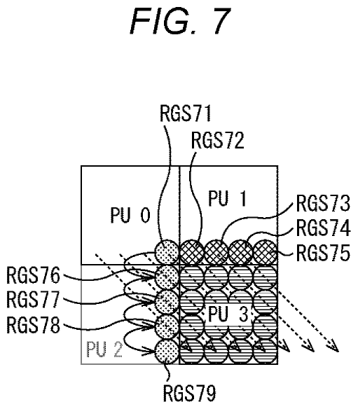

Similarly, in the case of performing intra prediction in HEVC, for example, assuming that pixels in PU3 are predicted by an intra prediction mode 18, as illustrated in FIG. 7.

In FIG. 7, PU0 to PU2 in the processing order earlier than PU3 are adjacent to the PU3, and the intra prediction processing is performed in order of the PU0, PU1, PU2, and PU3. Note that the processing order of these PUs is predetermined. Furthermore, the arrows in FIG. 7 represent the opposite direction to the reference direction in the intra prediction mode 18.

In this example, in the intra prediction of the PU3, a pixel RGS71 located in the PU0 and adjacent to the PU3, pixels RGS72 to RGS75 located in the PU1 and adjacent to the PU3, and pixels RGS76 to RGS79 located in the PU2 and adjacent to the PU3 are used as the adjacent pixels.

Since the pixels RGS71 to RGS79 used as the adjacent pixels are pixels in the PU0, PU1, and PU2 in the processing order earlier than the PU3, these pixels RGS71 to RGS79 are originally referable in the intra prediction in HEVC.

However, similarly to the example described with reference to FIG. 6, the pixel value of the pixel RGS71 that is another adjacent pixel adjacent to the PU2 is used as the pixel values of the pixels RGS76 to RGS79 in the PU2 processed immediately before the PU3 to be processed. In other words, the pixel values of the pixels RGS76 to RGS79 are substituted by the pixel value of the pixel RGS71.

The pixel RGS71 used as a substitute is an adjacent pixel adjacent to the PU2, that is, to the pixel RGS76, and located in the PU0 in the processing order earlier than the PU2. In particular, here, the pixel RGS71 is a pixel located at the lower right in FIG. 7 in the PU0.

By doing so, the pixels RGS76 to RGS79 in the PU2 processed immediately before the PU3 are not substantially referred to. Therefore, the intra prediction of the PU3 can be immediately started without waiting for completion of the local decoding of the PU2.

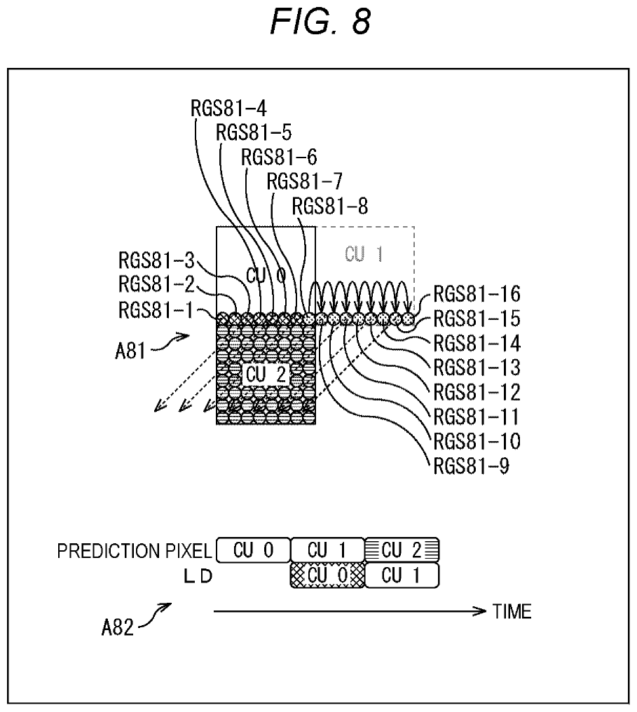

Furthermore, in the case of performing intra prediction in FVC (JEM4), for example, assuming that pixels in CU2 are predicted by the intra prediction mode 66, as illustrated with the arrow A81 in FIG. 8.

In the example illustrated with the arrow A81, CU0 and CU1 exist at positions adjacent to the CU2, and the intra prediction processing is performed in order of the CU0, CU1, and CU2. Note that the processing order of these CUs is predetermined. Furthermore, the arrows in FIG. 8 represent the opposite direction to the reference direction in the intra prediction mode 66.

In this example, in the intra prediction of the CU2, pixels RGS81-1 to RGS81-8 located in the CU0 and adjacent to the CU2 and pixels RGS81-9 to RGS81-16 located in the CU1 and in the vicinity of the CU2 are used as the adjacent pixels.

Since the pixels RGS81-1 to RGS81-16 used as the adjacent pixels are pixels in the CU0 and CU1 in the processing order earlier than the CU2, these pixels RGS81-1 to RGS81-16 are originally referable in the intra prediction in FVC.

However, similarly to the example described with reference to FIG. 6, the pixel value of the pixel RGS81-8 that is another adjacent pixel adjacent to the CU1 is used as the pixel values of the pixels RGS81-9 to RGS81-16 in the CU1 processed immediately before the CU2 to be processed. In other words, the pixel values of the pixels RGS81-9 to RGS81-16 are substituted by the pixel value of the pixel RGS81-8 without changing the pixel positions as the adjacent pixels of the pixels RGS81-9 to RGS81-16.

The pixel RGS81-8 used as a substitute is an adjacent pixel adjacent to the CU1 and located in the CU0 in the processing order earlier than the CU1. In particular, here, the pixel RGS81-8 is a pixel located at the lower right in FIG. 8 in the CU0.

By doing so, the intra prediction of the CU2 can be performed immediately after completion of the intra prediction of the CU0 and CU1, as illustrated with the arrow A82.

In this example, the local decoding of the CU0 is performed at the timing when the intra prediction of the CU1 is performed, the intra prediction of the CU2 can be performed immediately after completion of the intra prediction of the CU1 if the local decoding of the CU0 has been completed.

In the example described with reference to FIG. 4, the intra prediction of the CU2 cannot be started and pending (stall) occurs until completion of the local decoding of the CU1.

In contrast, in the example in FIG. 8, the pixel values of the adjacent pixels of the CU1 are substituted by the pixel value of the adjacent pixel of the CU0, whereby the intra prediction of the CU2 can be performed without waiting for the completion of the local decoding of the CU1 and without stalling the pipeline processing. Moreover, even in this case, the processing can be performed without changing the processing order of the CUs determined by FVC (JEM4), and the prediction operation of the pixel value of the pixel using the adjacent pixel determined by FVC (JEM4) can also be used without change. Thereby, a prediction pixel can be more easily and promptly obtained at a lower cost.

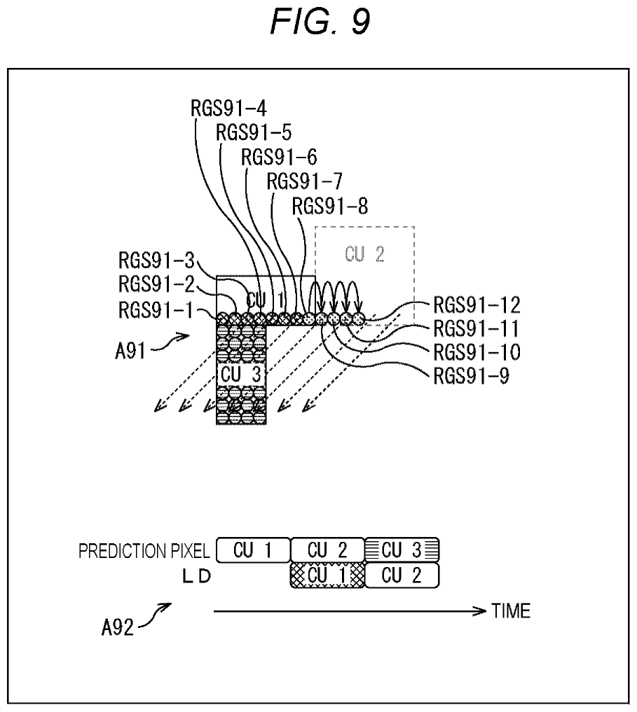

Similarly, in the case of performing intra prediction in FVC (JEM4), for example, assuming that pixels in CU3 are predicted by the intra prediction mode 66, as illustrated with the arrow A91 in FIG. 9.

In the example illustrated with the arrow A91, CU1 and CU2 exist at positions adjacent to the CU3, and the intra prediction processing is performed in order of the CU1, CU2, and CU3. Note that the processing order of these CUs is predetermined. Furthermore, the arrows in FIG. 9 represent the opposite direction to the reference direction in the intra prediction mode 66.

In this example, in the intra prediction of the CU3, pixels RGS91-1 to RGS91-8 located in the CU1 and adjacent to the CU3 and pixels RGS91-9 to RGS91-12 located in the CU2 and in the vicinity of the CU3 are used as the adjacent pixels.

Since the pixels RGS91-1 to RGS91-12 used as the adjacent pixels are pixels in the CU1 and CU2 in the processing order earlier than the CU3, these pixels RGS91-1 to RGS91-12 are originally referable in the intra prediction in FVC.

However, similarly to the example described with reference to FIG. 6, the pixel value of the pixel RGS91-8 that is another adjacent pixel adjacent to the CU2 is used as the pixel values of the pixels RGS91-9 to RGS91-12 in the CU2 processed immediately before the CU3 to be processed. In other words, the pixel values of the pixels RGS91-9 to RGS91-12 are substituted by the pixel value of the pixel RGS91-8.

The pixel RGS91-8 used as a substitute is an adjacent pixel adjacent to the CU2 and located in the CU1 in the processing order earlier than the CU2. In particular, here, the pixel RGS91-8 is a pixel located at the lower right in FIG. 9 in the CU1.

By doing so, the intra prediction of the CU3 can be performed immediately after completion of the intra prediction of the CU1 and CU2, as illustrated with the arrow A92.

In this example, the local decoding of the CU1 is performed at the timing when the intra prediction of the CU2 is performed, the intra prediction of the CU3 can be performed immediately after completion of the intra prediction of the CU2 if the local decoding of the CU1 has been completed.

In the example described with reference to FIG. 5, the intra prediction of the CU3 cannot be started and pending (stall) occurs until completion of the local decoding of the CU2. In contrast, in the example in FIG. 9, the pixel values of the adjacent pixels of the CU2 are substituted by the pixel value of the adjacent pixel of the CU1, whereby the intra prediction of the CU3 can be performed without waiting for the completion of the local decoding of the CU2 and without stalling the pipeline processing. Thereby, a prediction pixel can be more easily and promptly obtained at a lower cost.

### <Configuration Example of Image Encoding Device>

Next, an image encoding device as an image processing device to which the present technology is applied will be described.

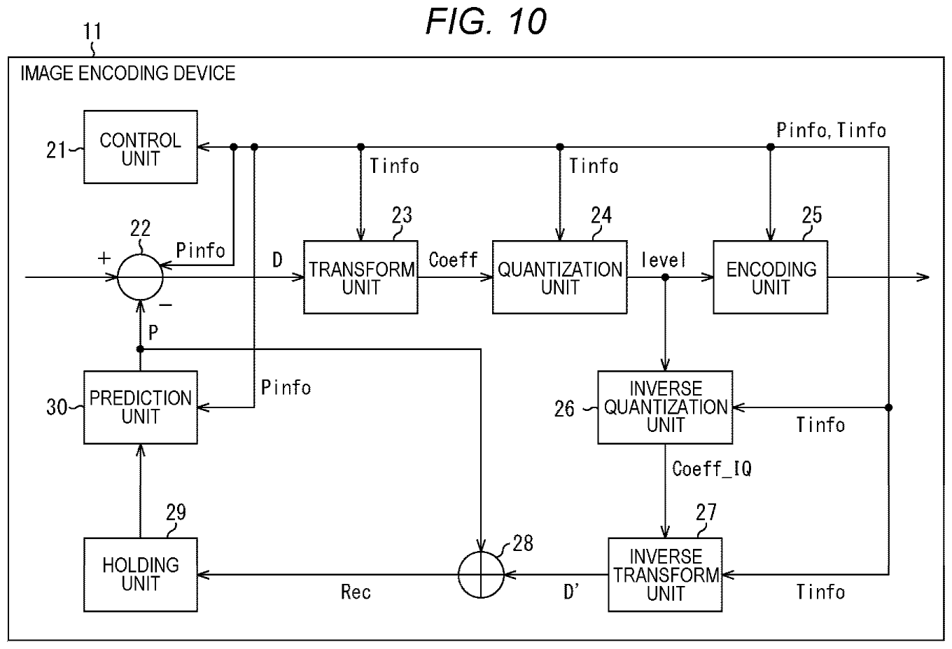

FIG. 10 is a diagram illustrating a configuration example of an embodiment of an image encoding device to which the present technology is applied.

An image encoding device 11 illustrated in FIG. 10 is an encoder that encodes a prediction residual between an image and a prediction image, such as AVC, HEVC, or FVC. Note that, hereinafter, description will be continued using a case in which the technology of HEVC is incorporated in the image encoding device 11 as an example.

Furthermore, FIG. 10 illustrates main processing units, data flows, and the like, and those illustrated in FIG. 10 are not necessarily everything. That is, in the image encoding device 11, there may be a processing unit not illustrated as a block in FIG. 10, or processing or data flow not illustrated as an arrow or the like in FIG. 10.

The image encoding device 11 includes a control unit 21, an operation unit 22, a transform unit 23, a quantization unit 24, an encoding unit 25, an inverse quantization unit 26, an inverse transform unit 27, an operation unit 28, a holding unit 29, and a prediction unit 30. The image encoding device 11 encodes, for each CU, a picture that is an input moving image in units of frames.

Specifically, the control unit 21 of the image encoding device 11 sets encoding parameters including header information Hinfo, prediction information Pinfo, transform information Tinfo, and the like on the basis of an input from an outside, and the like.

The header information Hinfo includes, for example, a video parameter set (VPS), a sequence parameter set (SPS), a picture parameter set (PPS), a slice header (SH), and the like.

The prediction information Pinfo includes, for example, a split flag indicating the presence or absence of division in the horizontal direction or the vertical direction in each division layer at the time of PU formation. Furthermore, the prediction information Pinfo includes, for each CU, prediction mode information indicating whether or not the prediction processing of the CU is intra prediction processing or inter prediction processing.

In the case where the prediction mode information indicates the intra prediction processing, the prediction information Pinfo includes a mode number indicating the intra prediction mode.

Furthermore, in the case where the prediction mode information indicates the intra prediction processing, the PPS includes, for example, constrained_intra_pred_flag that is flag information indicating a constraint when using adjacent pixels around a PU to be processed in predicting the PU to be processed in the intra prediction.

For example, in the case where a value of constrained_intra_pred_flag is 1, only a PU with which a prediction image has been generated by intra prediction, in other words, only adjacent pixels with which the intra prediction has been performed, of the adjacent pixels around the PU to be processed, are used for the intra prediction of the PU to be processed.

On the other hand, in the case where the value of constrained_intra_pred_flag is 0, not only the adjacent pixels around the PU to be processed and with which the intra prediction has been performed but also adjacent pixels with which inter prediction has been performed can be used for the intra prediction of the PU to be processed.

The transform information Tinfo includes TBSize indicating the size of a processing unit (transform block) called transform block (TB), and the like.

Furthermore, in the image encoding device 11, a picture (image) of a moving image to be encoded is supplied to the operation unit 22.

The operation unit 22 sequentially sets input pictures as pictures to be encoded, and sets a PU to be encoded to the picture to be encoded on the basis of the split flag of the prediction information Pinfo. The operation unit 22 subtracts a prediction image P in units of PUs supplied from the prediction unit 30 from an image I of the PU to be encoded to obtain a prediction residual D, and supplies the prediction residual D to the transform unit 23.

The transform unit 23 performs orthogonal transform and the like for the prediction residual D supplied from the operation unit 22 to derive a transform coefficient Coeff on the basis of the transform information Tinfo supplied from the control unit 21, and supplies the transform coefficient Coeff to the quantization unit 24.

The quantization unit 24 scales (quantizes) the transform coefficient Coeff supplied from the transform unit 23 to derive a quantized transform coefficient level level on the basis of the transform information Tinfo supplied from the control unit 21. The quantization unit 24 supplies the quantized transform coefficient level level to the encoding unit 25 and the inverse quantization unit 26.

The encoding unit 25 encodes the quantized transform coefficient level level and the like supplied from the quantization unit 24 by a predetermined method. For example, the encoding unit 25 transforms the encoding parameters (header information Hinfo, prediction information Pinfo, transform information Tinfo, and the like) supplied from the control unit 21, and the quantized transform coefficient level level supplied from the quantization unit 24 into syntax values of syntax elements according to definition of a syntax table. Then, the encoding unit 25 encodes the syntax values by arithmetic encoding or the like.

The encoding unit 25 multiplexes coded data that is a bit string of the syntax elements obtained as a result of the encoding, for example, and outputs the multiplexed coded data as a coded stream.

The inverse quantization unit 26 scales (inversely quantizes) the value of the quantized transform coefficient level level supplied from the quantization unit 24 to derive a transform coefficient Coeff_IQ after inverse quantization on the basis of the transform information Tinfo supplied from the control unit 21. The inverse quantization unit 26 supplies the transform coefficient Coeff_IQ to the inverse transform unit 27. The inverse quantization performed by the inverse quantization unit 26 is inverse processing of the quantization performed by the quantization unit 24, and is processing similar to inverse quantization performed in an image decoding device to be described below.

The inverse transform unit 27 performs inverse orthogonal transform and the like for the transform coefficient Coeff_IQ supplied from the inverse quantization unit 26 to derive a prediction residual D′ on the basis of the transform information Tinfo supplied from the control unit 21, and supplies the prediction residual D′ to the operation unit 28.

The inverse orthogonal transform performed by the inverse transform unit 27 is inverse processing of the orthogonal transform performed by the transform unit 23, and is processing similar to inverse orthogonal transform performed in the image decoding device to be described below.

The operation unit 28 adds the prediction residual D′ supplied from the inverse transform unit 27 with the prediction image P corresponding to the prediction residual D′ supplied from the prediction unit 30 to derive a local decoded image Rec. The operation unit 28 supplies the local decoded image Rec to the holding unit 29.

The holding unit 29 holds a part or all of the local decoded image Rec supplied from the operation unit 28. For example, the holding unit 29 includes a line memory for intra prediction and a frame memory for inter prediction. The holding unit 29 stores and holds a part of pixels of the decoded image Rec in the line memory at the time of intra prediction, and stores and holds the decoded image in units of pictures reconstructed using the decoded image Rec in the frame memory at the time of inter prediction.

The holding unit 29 reads the decoded image specified by the prediction unit 30 from the line memory or the frame memory and supplies the decoded image to the prediction unit 30. For example, the holding unit 29 reads the pixels of the decoded image, in other words, the adjacent pixels from the line memory and supplies the adjacent pixels to the prediction unit 30 at the time of intra prediction.

Note that the holding unit 29 may hold the header information Hinfo, prediction information Pinfo, transform information Tinfo, and the like related to generation of the decoded image.

The prediction unit 30 reads the decoded image from the holding unit 29 on the basis of the prediction mode information of the prediction information Pinfo, generates the prediction image P of the PU to be encoded by intra prediction processing or inter prediction processing, and supplies the prediction image P to the operation unit 22 and the operation unit 28.

### <Description of Image Encoding Processing>

Next, an operation of the image encoding device 11 described above will be described.

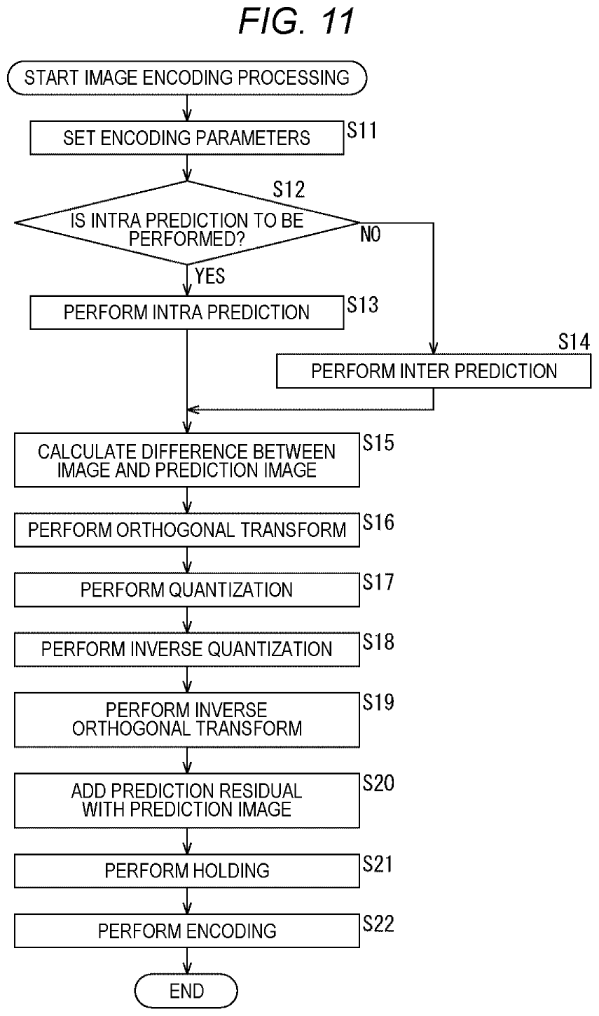

In other words, hereinafter image encoding processing by the image encoding device 11 will be described with reference to the flowchart in FIG. 11.

In step S11, the control unit 21 sets the encoding parameters on the basis of the input and the like from the outside, and supplies the set encoding parameters to each unit of the image encoding device 11.

In step S11, for example, the above-described header information Hinfo, prediction information Pinfo, transform information Tinfo, and the like are set as the encoding parameters. More specifically, for example, the split flag, the prediction mode information, the mode number, constrained_intra_pred_flag, and the like are set as the encoding parameters.

In step S12, the prediction unit 30 determines whether or not to perform intra prediction on the basis of the prediction mode information of the prediction information Pinfo supplied from the control unit 21.

In the case where the intra prediction is determined to be performed in step S12, in step S13, the prediction unit 30 performs the intra prediction to generate the prediction image P of the PU to be processed (encoded), and supplies the predicted to the operation unit 22 and the operation unit 28.

In other words, the prediction unit 30 reads the pixel value of the adjacent pixel from the holding unit 29 according to the intra prediction mode indicated by the mode number of the prediction information Pinfo supplied from the control unit 21. Here, a pixel in the vicinity of the PU to be processed in the picture in which the PU to be processed is included is the adjacent pixel.

The prediction unit 30 performs an operation determined for the intra prediction mode on the basis of the read pixel value of the adjacent pixel to predict the pixel value of each pixel of the PU to be processed to generate the prediction image P. When the prediction image P is obtained as described above, thereafter, the processing proceeds to step S15.

On the other hand, in the case where the intra prediction is determined not to be performed in step S12, in other words, in the case where the inter prediction is determined to be performed, the processing proceeds to step S14.

In step S14, the prediction unit 30 performs the inter prediction to generate the prediction image P of the PU to be processed (encoded), and supplies the prediction image P to the operation unit 22 and the operation unit 28.

In other words, the prediction unit 30 reads a picture of a frame (time) different from the picture including the PU to be processed from the holding unit 29 as a reference picture, and performs motion compensation and the like using the reference picture to generate the prediction image P.

When the prediction image P is obtained as described above, thereafter, the processing proceeds to step S15.

When the processing in step S13 or S14 is performed and the prediction image P is generated, in step S15, the operation unit 22 calculates a difference between the supplied image I and the prediction image P supplied from the prediction unit 30, and supplies the prediction residual D obtained as a result of the calculation to the transform unit 23.

In step S16, the transform unit 23 performs the orthogonal transform and the like for the prediction residual D supplied from the operation unit 22 on the basis of the transform information Tinfo supplied from the control unit 21, and supplies the transform coefficient Coeff obtained as a result of the orthogonal transform to the quantization unit 24.

In step S17, the quantization unit 24 scales (quantizes) the transform coefficient Coeff supplied from the transform unit 23 to derive the quantized transform coefficient level level on the basis of the transform information Tinfo supplied from the control unit 21. The quantization unit 24 supplies the quantized transform coefficient level level to the encoding unit 25 and the inverse quantization unit 26.

In step S18, the inverse quantization unit 26 inversely quantizes the quantized transform coefficient level level supplied from the quantization unit 24 with a characteristic corresponding to a characteristic of the quantization in step S17 on the basis of the transform information Tinfo supplied from the control unit 21. The inverse quantization unit 26 supplies the transform coefficient Coeff_IQ obtained by the inverse quantization to the inverse transform unit 27.

In step S19, the inverse transform unit 27 performs the inverse orthogonal transform and the like for the transform coefficient Coeff_IQ supplied from the inverse quantization unit 26 to derive the prediction residual D′ on the basis of the transform information Tinfo supplied from the control unit 21 by a method corresponding to the orthogonal transform in step S16. The inverse transform unit 27 supplies the obtained prediction residual D′ to the operation unit 28.

In step S20, the operation unit 28 adds the prediction residual D′ supplied from the inverse transform unit 27 with the prediction image P supplied from the prediction unit 30 to generate the local decoded image Rec, and supplies the decoded image Rec to the holding unit 29.

The above processing in steps S18 to S20 is processing of the local decoding at the time of image encoding processing.

In step S21, the holding unit 29 holds a part or all of the local decoded image Rec supplied from the operation unit 28 in the line memory or the frame memory in the holding unit 29.

In step S22, the encoding unit 25 encodes the encoding parameters set in the processing in step S11 and supplied from the control unit 21, and the quantized transform coefficient level level supplied from the quantization unit 24 by the processing in step S17 by a predetermined method.

The encoding unit 25 multiplexes the coded data obtained by the encoding to obtain the coded stream (bit stream) and outputs the coded stream to the outside of the image encoding device 11, and the image encoding processing is terminated.

In the case where the intra prediction processing is performed in step S13, for example, data obtained by encoding the mode number indicating the intra prediction mode and constrained_intra_pred_flag, data obtained by encoding the quantized transform coefficient level level, and the like are stored in the coded stream. The coded stream obtained in this way is transmitted to the decoding side via, for example, a transmission path or a recording medium.

### <Description of Intra Prediction Processing>

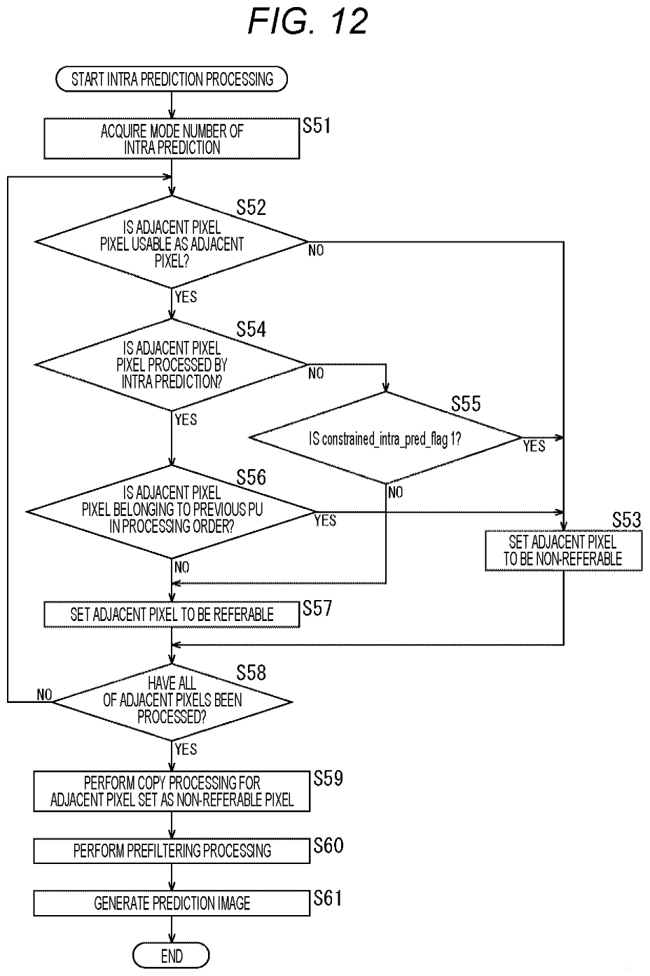

Next, more detailed processing in step S13 in FIG. 11 will be described. In other words, hereinafter, the intra prediction processing corresponding to the processing in step S13 in FIG. 11 performed by the prediction unit 30 will be described with reference to the flowchart in FIG. 12.

In step S51, the prediction unit 30 acquires the prediction information Pinfo from the control unit 21 to acquire the mode number indicating the intra prediction mode. Thereby, the prediction unit 30 can specify the intra prediction mode when performing the intra prediction such as generating the prediction image P in the intra prediction mode 34, for example. Furthermore, the prediction information Pinfo acquired by the prediction unit 30 includes constrained_intra_pred_flag.

When the intra prediction mode has been specified as described above, the number of the adjacent pixels and the positions of the adjacent pixels at the time of intra prediction of the PU to be processed can be specified from the intra prediction mode.

For example, in the example illustrated in FIG. 6, when the PU2 is the PU to be processed and the mode number of the intra prediction mode is 34, use of the pixels RGS61 to RGS64 of the PU0 and the pixels RGS65 to RGS68 of the PU1 as the adjacent pixels is specified.

When the adjacent pixels are specified, the prediction unit 30 selects the adjacent pixels one by one in order as adjacent pixels to be processed and processes the selected adjacent pixels.

In step S52, the prediction unit 30 determines whether or not the adjacent pixel to be processed is a pixel usable as the adjacent pixel on the basis of the positions of the adjacent pixel to be processed and the PU to be processed (encoded). In other words, whether or not the adjacent pixel to be processed is an adjacent pixel from which the pixel value is referable is determined.

For example, in a case where the adjacent pixel to be processed is a pixel outside the picture, in a case where the adjacent pixel to be processed is a pixel included in a slice or a tile different from a slice or a tile in which the PU to be processed is included, in a case where the adjacent pixel to be processed is a pixel in a PU in the processing order later than the PU to be processed, or the like, the adjacent pixel to be processed is determined not to be the pixel usable as the adjacent pixel.

Note that, hereinafter, the adjacent pixel from which the pixel value is referable is also referred to as a referable pixel, and the adjacent pixel from which the pixel value is not referable is also referred to as a non-referable pixel.

In the case where the adjacent pixel to be processed is determined not to be the usable pixel in step S52, in step S53, the prediction unit 30 sets the adjacent pixel to be processed to be non-referable. In other words, the adjacent pixel to be processed is regarded as the non-referable pixel.

After the processing in step S53 is performed, thereafter, the processing proceeds to step S58.

On the other hand, in the case where the adjacent pixel to be processed is determined to be the usable pixel in step S52, in step S54, the prediction unit 30 determines whether or not the adjacent pixel to be processed is a pixel processed by intra prediction.

In other words, in the case where the prediction image P of the PU including the adjacent pixel to be processed is generated by intra prediction, the adjacent pixel to be processed is determined to be the pixel processed by intra prediction in step S54.

In the case where the adjacent pixel to be processed is determined not to be the pixel processed by intra prediction, in other words, the adjacent pixel to be processed is determined to be a pixel processed by inter prediction in step S54, the processing proceeds to step S55.

In step S55, the prediction unit 30 determines whether or not the value of constrained_intra_pred_flag acquired from the control unit 21 in step S51 is 1.

In the case where the value of constrained_intra_pred_flag is determined to be 1 in step S55, the processing proceeds to step S53, and the adjacent pixel to be processed is set to be non-referable.

In the case where the value of the constrained_intra_pred_flag is 1, reference to surrounding pixels processed by inter prediction is prohibited when performing intra prediction of the PU to be processed.

In the case of performing the determination processing in step S55, the adjacent pixel to be processed is the pixel processed by inter prediction, and thus when the value of constrained_intra_pred_flag is determined to be 1 in step S55, the processing in step S53 is performed and the adjacent pixel to be processed is set as the non-referable pixel.

Furthermore, in the case where the value of constrained_intra_pred_flag is determined not to be 1, in other words, the value is determined to be 0 in step S55, thereafter, the processing proceeds to step S57.

In the case where the value of the constrained_intra_pred_flag is 0, reference to the surrounding pixels processed by inter prediction is possible when performing intra prediction of the PU to be processed. Therefore, the adjacent pixel to be processed can be set to be the referable pixel. Therefore, when the value of constrained_intra_pred_flag is determined to be 0 in step S55, the processing proceeds to step S57.

Note that, here, an example in which the processing proceeds to step S57 in the case where the value of constrained_intra_pred_flag is determined to be 0 in step S55 will be described. However, in the case where the value of constrained_intra_pred_flag is determined to be 0 in step S55, thereafter, the processing may proceed to step S56.

For example, in the case where the processing proceeds to step S57 when the value of constrained_intra_pred_flag is determined to be 0 in step S55, the substitution of the pixel value described with reference to FIGS. 6 to 9 is performed according to the processing order of the PU only when the PU including the adjacent pixel to be processed is a PU processed by intra prediction. That is, the substitution of the pixel value is not performed when the PU including the adjacent pixel to be processed is a PU processed by inter prediction.

On the other hand, in the case where the processing proceeds to step S56 when the value of constrained_intra_pred_flag is determined to be 0 in step S55, the substitution of the pixel value described with reference to FIGS. 6 to 9 is performed according to the processing order of the PU regardless of whether the PU including the adjacent pixel to be processed is the PU processed by intra prediction or the PU processed by inter prediction.

Furthermore, in the case where the adjacent pixel to be processed is determined to be the pixel processed by intra prediction in step S54, in step S56, the prediction unit 30 determines whether or not the adjacent pixel to be processed is a pixel belonging to a previous PU of the PU to be processed in the processing order.

For example, in the case where the PU2 is the PU to be processed in the example illustrated in FIG. 6, when the adjacent pixel to be processed is a pixel in the PU1, the adjacent pixel to be processed is determined to be the pixel belonging to the previous PU in step S56.

In the case where the adjacent pixel to be processed is determined to be the pixel belonging to the previous PU in step S56, thereafter, the processing proceeds to step S53 and the adjacent pixel to be processed is set as the non-referable pixel.

On the other hand, in the case where the adjacent pixel to be processed is determined not to be the pixel belonging to the previous PU in step S56, thereafter, the processing proceeds to step S57.

When the adjacent pixel to be processed is determined not to be the pixel belonging to the previous PU in step S56 or the value of constrained_intra_pred_flag is determined to be 0 in step S55, processing in step S57 is performed.

In step S57, the prediction unit 30 sets the adjacent pixel to be processed to be referable. In other words, the adjacent pixel to be processed is set as the referable pixel.

By the above processing in steps S52 to S57, the adjacent pixel to be processed is set as either the referable pixel or the non-referable pixel.

In other words, referable and non-referable of the adjacent pixel to be processed is determined on the basis of the positions of the PU to be processed and the adjacent pixel to be processed, processing order relationship determined by positional relationship between the PU in which the adjacent pixel to be processed is included and the PU to be processed, a reference prohibition constraint for the inter-predicted adjacent pixel by constrained_intra_pred_flag, or the like. These processes are similar not only in the case where the present technology is applied to HEVC but also in the case where the present technology is applied to FVC or the like.

The adjacent pixel to be processed is appropriately set as the non-referable pixel according to the positions of the PU to be processed and the adjacent pixel to be processed, the processing order of the PU, or the like, whereby the substitution with the pixel value of the pixel in the appropriate positional relationship with the adjacent pixel set as the non-referable pixel can be performed.

When the processing in step S53 or S57 is performed, the prediction unit 30 determines whether or not having processed all the adjacent pixels as the adjacent pixels to be processed in step S58.

In the case where all the adjacent pixels are determined to have not been performed yet in step S58, the processing returns to step S52 and the above-described processing is repeatedly performed. In other words, the adjacent pixel that has not been the adjacent pixel to be processed yet is set as the next adjacent pixel to be processed, and the processing in steps S52 to S57 is performed.

On the other hand, in the case where all the adjacent pixels are determined to have been performed in step S58, in step S59, the prediction unit 30 performs copy processing and substitutes the copied pixel value for the adjacent pixel set as the non-referable pixel.

In other words, for the adjacent pixel determined to be the pixel belonging to the previous PU in step S56 and set as the non-referable pixel, a pixel value of an adjacent pixel in a PU adjacent to the PU in which the adjacent pixel set as the non-referable pixel is included is copied and used as the pixel value of the adjacent pixel set as the non-referable pixel. In other words, substitution with the pixel value of another adjacent pixel in predetermined appropriate positional relationship is performed for the adjacent pixel set as the non-referable pixel.

Specifically, in the example illustrated in FIG. 6, for example, the pixel value of the pixel RGS64 as the adjacent pixel in the PU0 adjacent to the PU1 that includes the pixel RGS65 is substituted for the pixel value of the pixel RGS65 that is the adjacent pixel set as the non-referable pixel.

Furthermore, for the adjacent pixel set as the non-referable pixel by being determined not to be usable in step S52 or by being determined that the value of constrained_intra_pred_flag is 1 in step S55, the pixel value of another adjacent pixel in the vicinity of the adjacent pixel set as the non-referable pixel is copied and used as the pixel value of the adjacent pixel set as the non-referable pixel. In other words, the pixel value of the appropriate another adjacent pixel determined by a predetermined method is used for the adjacent pixel set as the non-referable pixel.

When the processing in step S59 is performed, the pixel values of the adjacent pixels are obtained for all the adjacent pixels.

In step S60, the prediction unit 30 performs prefiltering processing on the basis of the pixel values of the adjacent pixels to obtain the pixel value of the final adjacent pixel. For example, in the prefiltering processing, the pixel value of final one adjacent pixel is calculated on the basis of the pixel values of some adjacent pixels arranged in series.

In step S61, the prediction unit 30 obtains (generates) the pixel values of the pixels in the PU to be processed by intra prediction on the basis of the pixel value of the final adjacent pixel obtained in the processing in step S60, thereby generating an image of the PU to be processed as the prediction image P. In other words, the pixel values of the prediction pixels that are the pixels in the PU to be processed are generated according to the intra prediction mode indicated by the mode number acquired in step S51.

When the prediction image P is obtained, the obtained prediction image P is supplied to the operation unit 22 and the operation unit 28, and the intra prediction processing is terminated.

As described above, the image encoding device 11 sets each adjacent pixel as the referable pixel or the non-referable pixel, and copies and uses the pixel value of another adjacent pixel as the adjacent pixel set as the non-referable pixel. In particular, the adjacent pixel in the PU processed immediately before the PU to be processed is originally the pixel set as the referable pixel. However, the adjacent pixel is set as the non-referable pixel and substitution with the pixel value of another adjacent pixel is performed, whereby reference to the adjacent pixel of the PU that becomes a previous block is substantially eliminated. Thereby, a prediction pixel can be more easily and promptly obtained at a lower cost.

### <Configuration Example of Image Decoding Device>

Next, an image decoding device as an image processing device to which the present technology is applied, the image decoding device for decoding a coded stream output from the image encoding device 11 illustrated in FIG. 10, will be described.

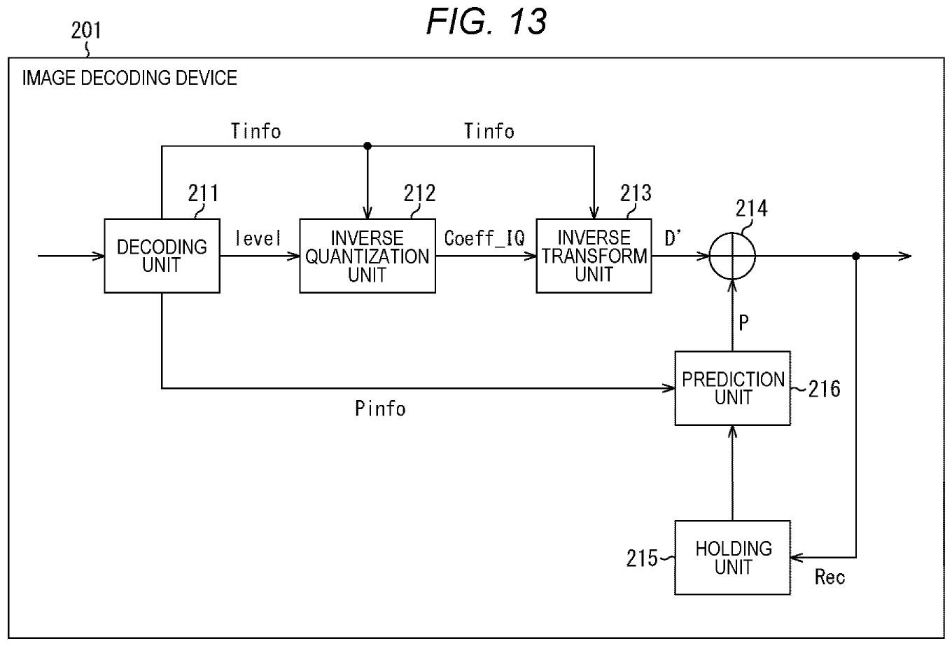

FIG. 13 is a diagram illustrating a configuration example of an embodiment of an image decoding device to which the present technology is applied.

An image decoding device 201 illustrated in FIG. 13 decodes the coded stream generated by the image encoding device 11 by a decoding method corresponding to the encoding method in the image encoding device 11. Here, it is assumed that the technology of HEVC is incorporated in the image decoding device 201.

Note that FIG. 13 illustrates main processing units, data flows, and the like, and those illustrated in FIG. 13 are not necessarily everything. That is, in the image decoding device 201, there may be a processing unit not illustrated as a block in FIG. 13, or processing or data flow not illustrated as an arrow or the like in FIG. 13.

The image decoding device 201 includes a decoding unit 211, an inverse quantization unit 212, an inverse transform unit 213, an operation unit 214, a holding unit 215, and a prediction unit 216.

The image decoding device 201 decodes the input coded stream.

The decoding unit 211 decodes the supplied coded stream by a predetermined decoding method corresponding to the encoding method in the encoding unit 25. In other words, the decoding unit 211 decodes the encoding parameters of the header information Hinfo, prediction information Pinfo, transform information Tinfo, and the like, and the quantized transform coefficient level level from the bit string of the coded stream according to the definition of the syntax table.

For example, the decoding unit 211 divides the CU on the basis of the split flag included in the encoding parameters, and sequentially sets PUs corresponding to the quantized transform coefficient levels level to blocks to be decoded.

Furthermore, the decoding unit 211 supplies the encoding parameters obtained by the decoding to the blocks of the image decoding device 201. For example, the decoding unit 211 supplies the prediction information Pinfo to the prediction unit 216, supplies the transform information Tinfo to the inverse quantization unit 212 and the inverse transform unit 213, and supplies the header information Hinfo to the blocks. Furthermore, the decoding unit 211 supplies the quantized transform coefficient level level to the inverse quantization unit 212.

The inverse quantization unit 212 scales (inversely quantizes) the value of the quantized transform coefficient level level supplied from the decoding unit 211 to derive the transform coefficient Coeff_IQ on the basis of the transform information Tinfo supplied from the decoding unit 211. This inverse quantization is inverse processing of the quantization performed by the quantization unit 24 of the image encoding device 11. Note that the inverse quantization unit 26 performs similar inverse quantization to the inverse quantization unit 212. The inverse quantization unit 212 supplies the obtained transform coefficient Coeff_IQ to the inverse transform unit 213.

The inverse transform unit 213 performs inverse orthogonal transform and the like for the transform coefficient Coeff_IQ supplied from the inverse quantization unit 212 on the basis of the transform information Tinfo and the like supplied from the decoding unit 211, and supplies the prediction residual D′ obtained as a result of the inverse orthogonal transform to the operation unit 214.

The inverse orthogonal transform performed by the inverse transform unit 213 is inverse processing of the orthogonal transform performed by the transform unit 23 of the image encoding device 11. Note that the inverse transform unit 27 performs similar inverse orthogonal transform to the inverse transform unit 213.

The operation unit 214 adds the prediction residual D′ supplied from the inverse transform unit 213 with the prediction image P corresponding to the prediction residual D′ to derive the local decoded image Rec.

The operation unit 214 reconstructs the decoded image in units of pictures using the obtained local decoded image Rec, and outputs the obtained decoded image to the outside. Furthermore, the operation unit 214 supplies the local decoded image Rec to the holding unit 215.

The holding unit 215 holds a part or all of the local decoded image Rec supplied from the operation unit 214. For example, the holding unit 215 includes a line memory for intra prediction and a frame memory for inter prediction. The holding unit 215 stores and holds a part of pixels of the decoded image Rec in the line memory at the time of intra prediction, and stores and holds the decoded image in units of pictures reconstructed using the decoded image Rec in the frame memory at the time of inter prediction.

The holding unit 215 reads the decoded image specified by the prediction unit 216 from the line memory or the frame memory and supplies the decoded image to the prediction unit 216. For example, the holding unit 215 reads the pixels of the decoded image, in other words, the adjacent pixels from the line memory and supplies the adjacent pixels to the prediction unit 216 at the time of intra prediction.

Note that the holding unit 215 may hold the header information Hinfo, prediction information Pinfo, transform information Tinfo, and the like related to generation of the decoded image.

The prediction unit 216 reads the decoded image from the holding unit 215 on the basis of the prediction mode information of the prediction information Pinfo, generates the prediction image P of the PU to be decoded by intra prediction processing or inter prediction processing, and supplies the prediction image P to the operation unit 214.

### <Description of Image Decoding Processing>

Next, an operation of the image decoding device 201 will be described.

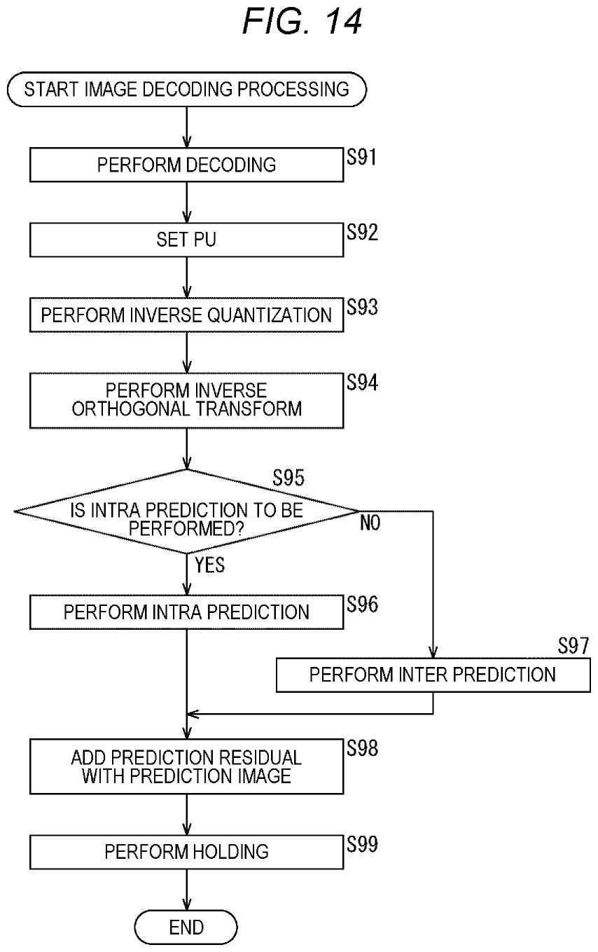

In other words, hereinafter, image decoding processing by the image decoding device 201 will be described with reference to the flowchart in FIG. 14. Note that this image decoding processing is performed for each PU.

In step S91, the decoding unit 211 decodes the coded stream supplied to the image decoding device 201 to obtain the encoding parameters and the quantized transform coefficient level level.

The decoding unit 211 supplies the encoding parameters to the units of the image decoding device 201, and supplies the quantized transform coefficient level level to the inverse quantization unit 212.

Thereby, the prediction mode information and the mode number as the prediction information Pinfo, constrained_intra_pred_flag as the header information Hinfo, and the like are supplied from the decoding unit 211 to the prediction unit 216, for example.

In step S92, the decoding unit 211 divides the CU on the basis of the split flag included in the encoding parameters and sets a PU to be decoded.

In step S93, the inverse quantization unit 212 inversely quantizes the quantized transform coefficient level level supplied from the decoding unit 211 to derive the transform coefficient Coeff_IQ, and supplies the transform coefficient Coeff_IQ to the inverse transform unit 213.

In step S94, the inverse transform unit 213 performs the inverse orthogonal transform and the like for the transform coefficient Coeff_IQ supplied from the inverse quantization unit 212, and supplies the prediction residual D′ obtained as a result of the inverse orthogonal transform to the operation unit 214.

In step S95, the prediction unit 216 determines whether or not to perform intra prediction on the basis of the prediction mode information supplied from the decoding unit 211.

In the case where the intra prediction is determined to be performed in step S95, thereafter, the processing proceeds to step S96.

In step S96, the prediction unit 216 reads a decoded image (adjacent pixel) from the holding unit 215 according to the intra prediction mode indicated by the mode number supplied from the decoding unit 211 and performs the intra prediction. In other words, the prediction unit 216 generates the prediction image P on the basis of the decoded image (adjacent pixel) according to the intra prediction mode and supplies the prediction image P to the operation unit 214. When the prediction image P is generated, thereafter, the processing proceeds to step S98.

On the other hand, in the case where the intra prediction is determined not to be performed, in other words, the inter prediction is determined to be performed in step S95, the processing proceeds to step S97 and the prediction unit 216 performs the inter prediction.

In other words, in step S97, the prediction unit 216 reads a picture of a frame (time) different from the picture including the PU to be decoded from the holding unit 215 as a reference picture and performs motion compensation and the like using the reference picture to generate the prediction image P, and supplies the prediction image P to the operation unit 214. When the prediction image P is generated, thereafter, the processing proceeds to step S98.

When the processing in step S96 or S97 is performed and the prediction image P is generated, in step S98, the operation unit 214 adds the prediction residual D′ supplied from the inverse transform unit 213 with the prediction image P supplied from the prediction unit 216 to derive the local decoded image Rec. The operation unit 214 reconstructs the decoded image in units of pictures using the obtained local decoded image Rec, and outputs the obtained decoded image to the outside of the image decoding device 201. Furthermore, the operation unit 214 also supplies the local decoded image Rec to the holding unit 215.

In step S99, the holding unit 215 holds the local decoded image Rec supplied from the operation unit 214, and the image decoding processing is terminated.

The image decoding device 201 generates the prediction image according to the prediction mode information and obtains the decoded image as described above.

### <Description of Intra Prediction Processing>

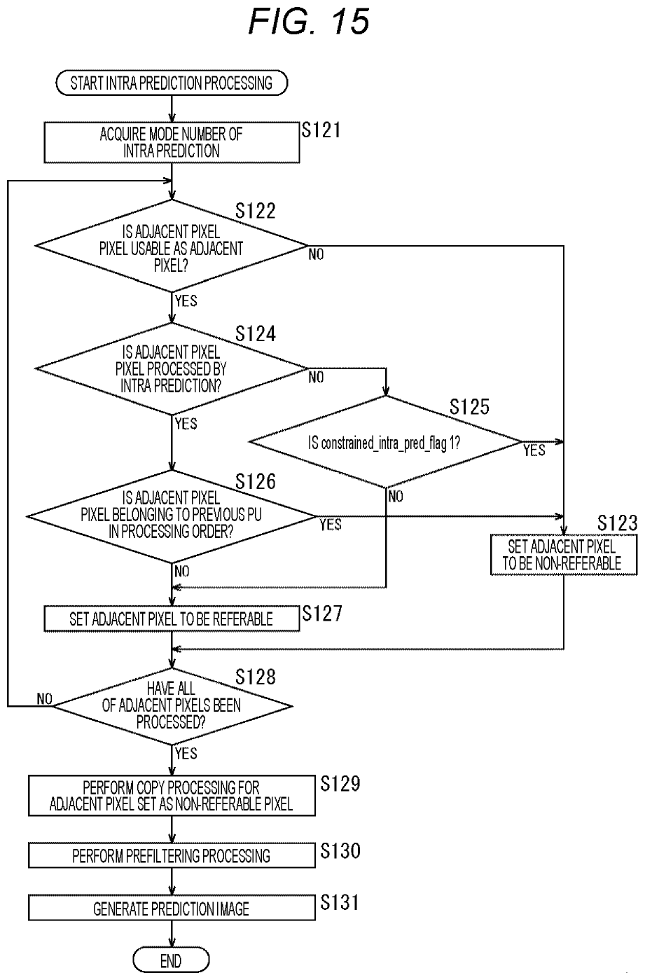

Next, more detailed processing of step S96 in FIG. 14 will be described. In other words, hereinafter, intra prediction processing corresponding to the processing of step S96 in FIG. 14 performed by the prediction unit 216 will be described with reference to the flowchart in FIG. 15.

In the intra prediction processing, processing in step S121 to step S131 is performed by the prediction unit 216 and the intra prediction processing is terminated. This processing is similar to the processing in steps S51 to S61 in FIG. 12 and thus description is omitted.

Note that, in step S121, the prediction unit 216 acquires the mode number indicating the intra prediction mode from the decoding unit 211. Furthermore, in step S125, the prediction unit 216 performs determination on the basis of constrained_intra_pred_flag acquired from the decoding unit 211.

As described above, the substitution with the pixel value of another adjacent pixel is performed using the adjacent pixel in the PU processed immediately before the PU to be processed as the non-referable pixel even in the prediction unit 216, whereby a prediction pixel can be more easily and promptly obtained at a lower cost.

### Second Embodiment

### <Application of Substitute Intra Prediction>

By the way, in the above description, regarding the pixel value of the adjacent pixel in positional relationship of inhibiting the pipeline processing and parallel processing at the time of intra prediction, a method of efficiently generating pixels in terms of performance in intra prediction by substituting the pixel values with the pixel value of another adjacent pixel located at a position not affecting the performance (processing speed) of the intra prediction has been described.

However, in a case where the difference between the pixel value to be substituted and the pixel value as a substitute is large, there is a concern of image quality deterioration when the pixels in the intra prediction are generated by substitution (copy) of the pixel value of the adjacent pixel and it is not a good idea to always generate the pixels in intra prediction by the substitution of the pixel value.

Therefore, a normal intra prediction mode of performing operations as performed in general intra prediction such as HEVC and FVC, and a substitute intra prediction mode of performing substitution of a pixel value of an adjacent pixel described in the first embodiment to perform intra prediction may be able to be switched.

Hereinafter, the intra prediction performed in HEVC, EVC, or the like will be also referred to as normal intra prediction, and the intra prediction of substituting the pixel value of another adjacent pixel for the pixel value of the adjacent pixel in the PU processed immediately before the PU to be processed described with reference to FIGS. 12 and 15 will be also referred to as substitute intra prediction.

For example, in a case of making the normal intra prediction mode of performing the normal intra prediction and the substitute intra prediction mode of performing the substitute intra prediction switchable, application information regarding application of the substitute intra prediction is only required to be stored in a coded stream (bit stream).

Specifically, it is conceivable to define constrained_intra_pred_direction_flag that is one-bit flag information indicating which intra prediction of the normal intra prediction mode and the substitute intra prediction mode is to be performed as the application information, for example, and store constrained_intra_pred_direction_flag in SPS or PPS in the coded stream.

Here, in a case where a value of constrained_intra_pred_direction_flag is 0, the value indicates that a prediction image P is to be generated by the normal intra prediction mode. In a case where the value of constrained_intra_pred_direction_flag is 1, the value indicates that the prediction image P is to be generated by the substitute intra prediction mode.

Such constrained_intra_pred_direction_flag is information regarding an application condition of the substitute intra prediction for turning on and off the substitute intra prediction, in other words, the substitution of a pixel value of another adjacent pixel.

By sharing constrained_intra_pred_direction_flag by an image encoding device 11 and an image decoding device 201 in this manner, a prediction image can be generated by the same operation (same mode) by the image encoding device 11 and the image decoding device 201 at the time of intra prediction.

Note that the value of constrained_intra_pred_direction_flag may be determined for each PU, for each frame or slice, or for each stream.

Furthermore, in intra prediction, the smaller the size of a prediction block such as a PU, the larger the impact of pipeline installation. In other words, the larger the size of the prediction block, the shorter the stall time for waiting for local decoding. Furthermore, the difference between the pixel value to be substituted and the pixel value as a substitute tends to be larger as the size of the prediction block is larger.

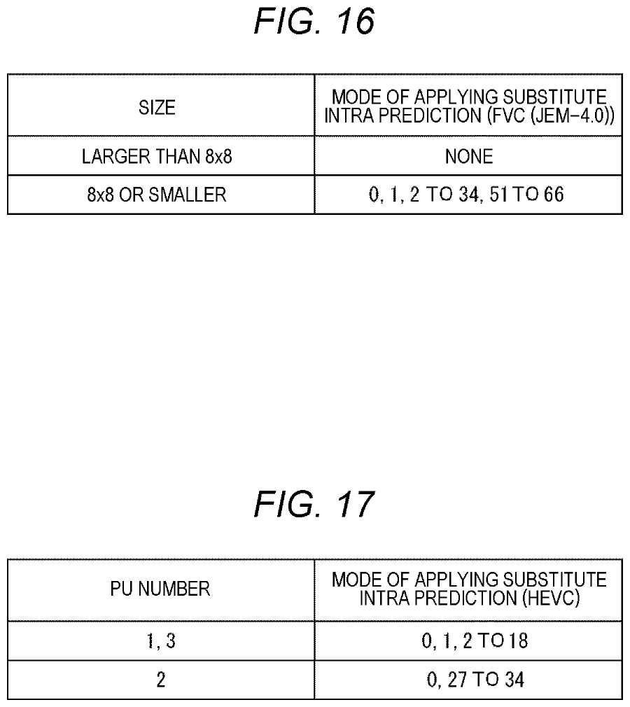

For these reasons, even in the case of the substitute intra prediction mode, it is appropriate to apply the substitute intra prediction only to a prediction block that is small in some degree as illustrated in FIG. 16, for example.

In other words, in the case of applying the present technology to FVC (JEM4), for example, the application condition as to whether or not to apply the substitute intra prediction to a CU that is a prediction block (current block) to be processed can be determined, as illustrated in FIG. 16.

In this example, in a case where the size of the CU that is the prediction block is larger than 8 pixels×8 pixels, the normal intra prediction is performed without performing the substitute intra prediction even in the substitute intra prediction mode.

In contrast, in a case where the size of the CU that is prediction block is 8 pixels×8 pixels or smaller, the substitute intra prediction is performed in the CU when a mode number of the intra prediction mode is any of 0, 1, 2 to 34, and 51 to 66, and the normal intra prediction is performed when the mode number is a number other than the aforementioned numbers.

By determining whether or not to perform the substitute intra prediction on the basis of the size of the prediction block and the intra prediction mode (mode number) in the prediction block, more appropriate prediction between the substitute intra prediction and the normal intra prediction can be applied to the prediction block. Note that which is more appropriate intra prediction can be determined according to the size of the prediction block, and a reference direction and an adjacent pixel position determined by the intra prediction mode.

Furthermore, in a case where a plurality of PUs is included in the CU, like HEVC, for example, the application condition as to whether or not to apply the substitute intra prediction may be determined using PU numbers and the intra prediction mode in addition to the sizes of the PUs.

Specifically, in the case of applying the present technology to HEVC, for example, the application condition as to whether or not to apply the substitute intra prediction to a PU that is a prediction block (current block) to be processed can be determined, as illustrated in FIG. 17.

In this example, whether or not to perform the substitute intra prediction is determined on the basis of the size of the PU, the PU number, in other words, the position of the PU (processing order), and the intra prediction mode (mode number). Note that although not illustrated here, the substitute intra prediction can be applied to the PU only in a case where the size of the PU is equal to or smaller than a specific size such as 8 pixels×8 pixels or 4 pixels×4 pixels.

In other words, for a PU with the PU number of 1 or 3 among PUs having the specific size or smaller, the substitute intra prediction is performed for the PU when the mode number of the intra prediction mode is any of 0, 1, and 2 to 18, and the normal intra prediction is performed when the mode number is a number other than the aforementioned numbers.

Furthermore, for a PU with the PU number of 2 among the PUs having the specific size or smaller, the substitute intra prediction is performed for the PU when the mode number of the intra prediction mode is any of 0, and 27 to 34, and the normal intra prediction is performed when the mode number is a number other than the aforementioned numbers.

By determining whether or not to perform the substitute intra prediction according to whether or not satisfying the application condition determined according to the size of the PU that is the prediction block, the PU number, and the intra prediction mode (mode number), prediction (generation) of pixels can be more appropriately performed.

As described above, as the application condition to perform the substitute intra prediction in the prediction block (current block), a condition determined according to at least any one of the size of the current block, the processing order (CU number or PU number) of the current block, or the intra prediction mode in the current block can be determined. In this case, for example, in a case where the number of constrained_intra_pred_direction_flag is 1, in other words, the value is a value indicating to perform the substitute intra prediction, and the current block satisfies the predetermined application condition, pixels in the current block can be generated by the substitute intra prediction.

### <Description of Image Encoding Processing>

Moreover, as an example of a determination criterion of when the image encoding device 11 sets (determines) the value of constrained_intra_pred_direction_flag, the magnitude of a frame (picture) of a moving image to be encoded, in other words, the size of a picture, high and low of a frame rate of the moving image, high and low of a bit rate of the moving image, or the like is conceivable. In other words, constrained_intra_pred_direction_flag may be generated on the basis of information regarding the moving image to be encoded, such as the frame size, frame rate, or bit rate of the moving image to be encoded.

As an example, a case in which the substitute intra prediction is performed in a case where the size of the frame of the moving image is 4 K or larger, in other words, the value of constrained_intra_pred_direction_flag is 1 will be described.

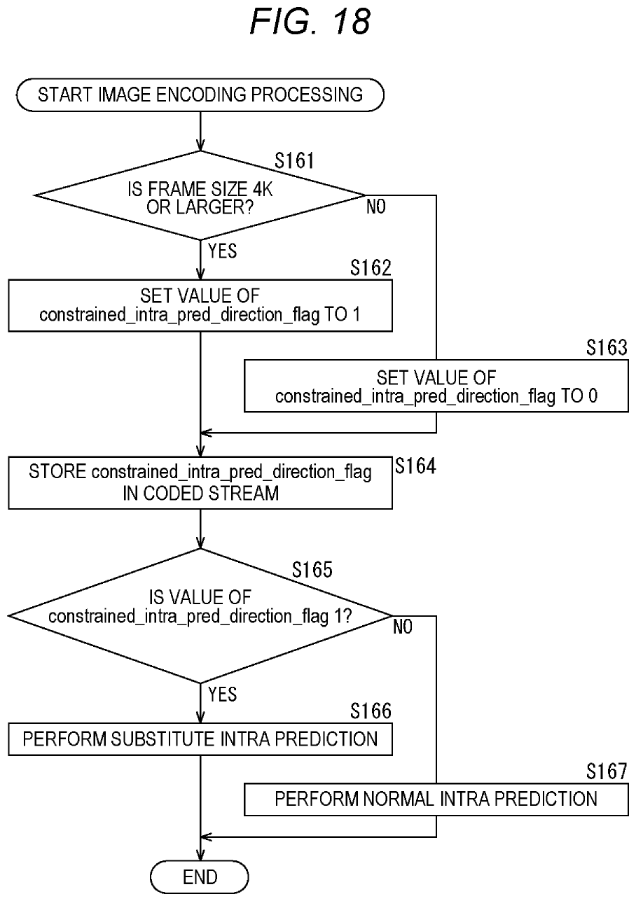

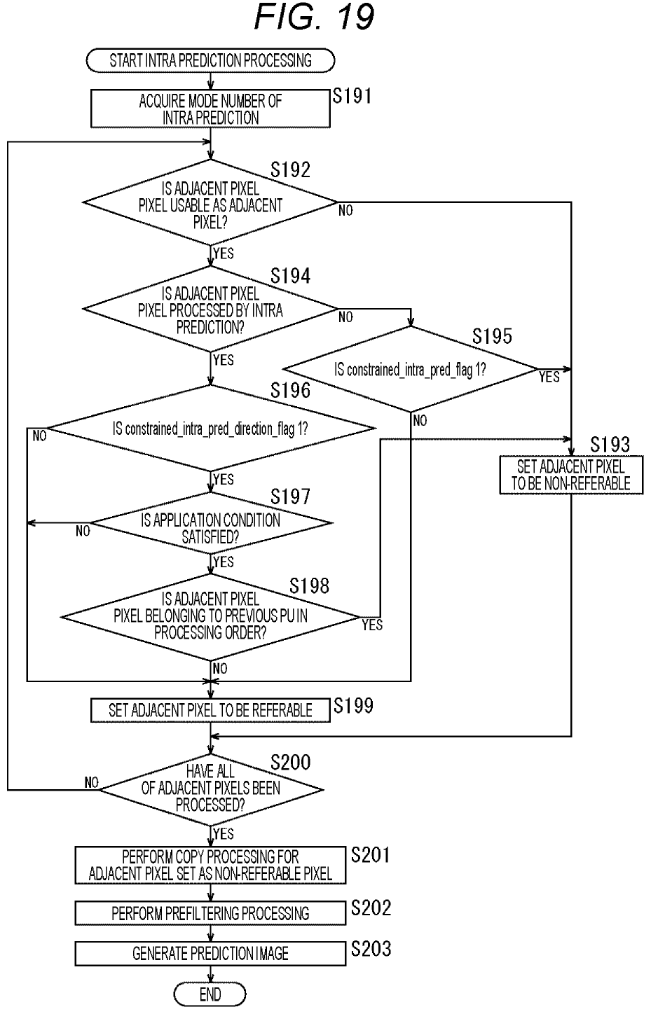

In this case, in the image encoding device 11, image encoding processing illustrated in FIG. 18 is roughly performed when a prediction image is generated by intra prediction. Hereinafter, the image encoding processing by the image encoding device 11 will be described with reference to the flowchart in FIG. 18.

In step S161, a control unit 21 determines whether or not the frame size (resolution) of the frame (picture) of the moving image to be encoded is 4 K or larger.

In the case where the frame size is determined to be 4 K or larger in step S161, in step S162, the control unit 21 sets the value of constrained_intra_pred_direction_flag to 1.

Here, the size of 4 K is used as the frame size serving as a threshold for determining the value of constrained_intra_pred_direction_flag.

Furthermore, the control unit 21 supplies encoding parameters including constrained_intra_pred_direction_flag and the like to an encoding unit 25 and also supplies constrained_intra_pred_direction_flag and the like to a prediction unit 30, and the processing proceeds to step S164.

On the other hand, in the case where the frame size is determined to be less than 4 K in step S161, in step S163, the control unit 21 sets the value of constrained_intra_pred_direction_flag to 0.

Furthermore, the control unit 21 supplies encoding parameters including constrained_intra_pred_direction_flag and the like to an encoding unit 25 and also supplies constrained_intra_pred_direction_flag and the like to a prediction unit 30, and the processing proceeds to step S164.

When the processing in step S162 or S163 is performed, in step S164, the encoding unit 25 stores, in a coded stream, the encoding parameters including constrained_intra_pred_direction_flag and the like supplied from the control unit 21. In other words, the encoding unit 25 encodes constrained_intra_pred_direction_flag, and the like.

In step S165, the prediction unit 30 determines whether or not the value of constrained_intra_pred_direction_flag supplied from the control unit 21 is 1.

In the case where the value is determined to be 1 in step S165, in step S166, the prediction unit 30 generates the prediction image P by the substitute intra prediction and supplies the prediction image P to an operation unit 22 and an operation unit 28, and the image encoding processing is terminated.

Meanwhile, in the case where the value is determined not to be 1 in step S165, in other words, the value is determined to be 0, in step S167, the prediction unit 30 generates the prediction image P by the normal intra prediction and supplies the prediction image P to the operation unit 22 and the operation unit 28, and the image encoding processing is terminated.

As described above, the image encoding device 11 determines the value of the constrained_intra_pred_direction_flag according to the frame size, and generates the prediction image by the intra prediction according to the determination result. Thereby, more appropriate prediction between the substitute intra prediction and the normal intra prediction can be selected. As a result, a high-quality prediction image can be promptly obtained while permitting occurrence of a certain degree of stall.

Note that, more specifically, the processing in steps S161 to S163 in FIG. 18 is performed as part of processing in step S11 in FIG. 11, and the processing in step S164 in FIG. 18 corresponds to step S22 in FIG. 11.

### <Description of Intra Prediction Processing>

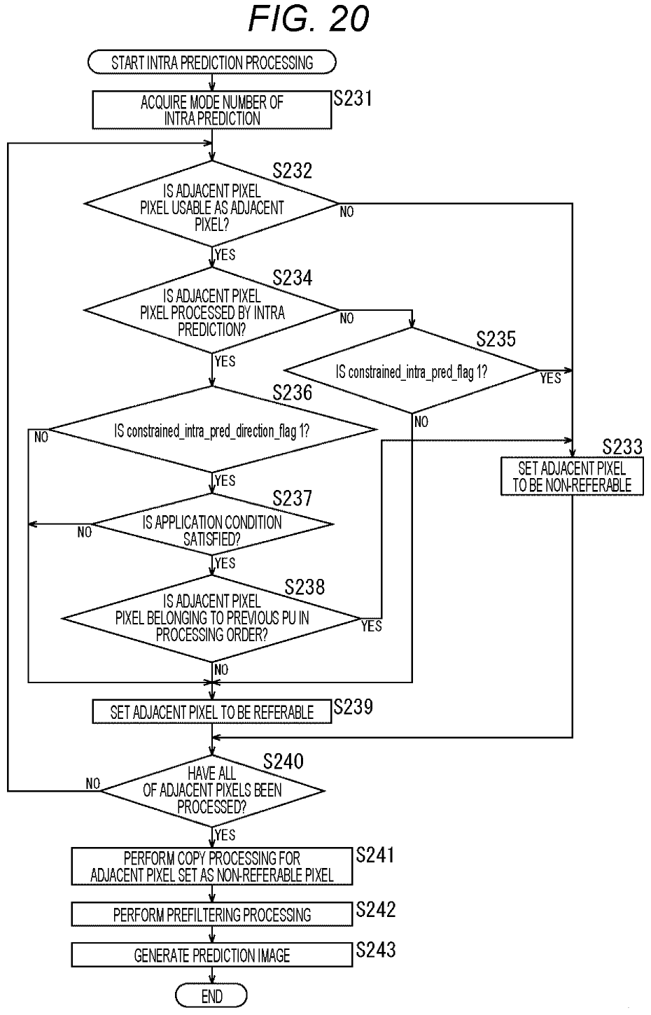

Furthermore, the processing in steps S165 to S167 in FIG. 18 corresponds to the processing in step S13 in FIG. 11. In this case, more specifically, the intra prediction processing illustrated in FIG. 19 is performed as the processing in step S13.

Hereinafter, the intra prediction processing by the prediction unit 30 will be described with reference to the flowchart in FIG. 19. Note that processing in steps S191 to S195 is similar to the processing in steps S51 to S55 in FIG. 12, and thus description is omitted.

Note that, in step S191, the prediction unit 30 acquires constrained_intra_pred_flag together with the mode number and constrained_intra_pred_direction_flag from the control unit 21.

Furthermore, in the case where an adjacent pixel to be processed is determined to be a pixel processed by intra prediction in step S194, the processing proceeds to step S196.

In step S196, the prediction unit 30 determines whether or not the value of constrained_intra_pred_direction_flag is 1.

In a case where the value of constrained_intra_pred_direction_flag is determined not to be 1, in other words, the value is determined to be 0 in step S196, the substitute intra prediction is not performed and the normal intra prediction is performed. Therefore, processing in steps S197 and S198 is skipped and the processing proceeds to step S199.

On the other hand, in the case where the value of constrained_intra_pred_direction_flag is determined to be 1 in step S196, the prediction mode is the substitute intra prediction mode, and the processing proceeds to step S197.

In step S197, the prediction unit 30 determines whether or not the PU to be processed satisfies the application condition of the substitute intra prediction.

For example, the application condition of the substitute intra prediction is a condition determined according to the size of the PU to be processed, the PU number of the PU to be processed, in other words, the position (processing order) of the PU to be processed in the CU, and the mode number of the intra prediction mode, as illustrated in FIG. 17.

Therefore, in the case where the application condition is the condition illustrated in FIG. 17, for example, the PU to be processed is determined to satisfy the application condition in step S197, when the size of the PU to be processed is 4 pixels×4 pixels, the PU number of the PU to be processed is 2, and the mode number of the intra prediction mode of the PU to be processed is 0.

In the case where the PU to be processed is determined not to satisfy the application condition in step S197, the prediction mode is the substitute intra prediction mode but the normal intra prediction is performed for the PU to be processed. Therefore, processing in step S198 is skipped and the processing proceeds to step S199.

On the other hand, in the case where the PU to be processed is determined to satisfy the application condition in step S197, the substitute intra prediction is performed, and therefore the processing proceeds to step S198.

In step S198, the prediction unit 30 determines whether or not the adjacent pixel to be processed is a pixel belonging to a PU immediately before the PU to be processed in the processing order. In step S198, similar determination processing to the processing in step S56 in FIG. 12 is performed.

In the case where the adjacent pixel to be processed is determined to be the pixel belonging to the previous PU in step S198, thereafter, the processing proceeds to step S193 and the adjacent pixel to be processed is set as the non-referable pixel.

On the other hand, in the case where the adjacent pixel to be processed is determined not to be the pixel belonging to the previous PU in step S198, thereafter, the processing proceeds to step S199.

In the case where the value of constrained_intra_pred_flag is determined to be 0 in step S195, the value of constrained_intra_pred_direction_flag is determined to be 0 in step S196, the application condition is determined not to be satisfied in step S197, or the adjacent pixel to be processed is determined not to be the pixel belonging to the previous PU in step S198, processing in step S199 is performed. In other words, in step S199, the prediction unit 30 sets the adjacent pixel to be processed to be referable.

When the processing in step S193 or S199 is performed, thereafter, processing in steps S200 to S203 is performed and the intra prediction processing is terminated. This processing is similar to the processing in steps S58 to S61 in FIG. 12, and thus description is omitted.

The prediction unit 30 determines whether or not to perform the substitute intra prediction or the normal intra prediction on the basis of constrained_intra_pred_direction_flag and the application condition, as described above, and generates the prediction image according to the determination result. By doing so, more appropriate prediction between the substitute intra prediction and the normal intra prediction can be applied to each PU to be processed, and a high-quality prediction image can be promptly obtained while permitting a certain degree of stall.

### <Description of Intra Prediction Processing>

Furthermore, in the case where constrained_intra_pred_direction_flag is stored in the coded stream, the image decoding device 201 performs the image decoding processing described with reference to FIG. 14.

At that time, in step S91, a decoding unit 211 also reads constrained_intra_pred_direction_flag from the coded stream and supplies constrained_intra_pred_direction_flag to a prediction unit 216. In other words, the decoding unit 211 decodes constrained_intra_pred_direction_flag. Then, the intra prediction processing illustrated in FIG. 20 is performed as the processing corresponding to step S96.

Hereinafter, intra prediction processing corresponding to the processing in step S96 in FIG. 14 will be described with reference to the flowchart in FIG. 20. In the intra prediction processing, processing in step S231 to step S243 is performed by the prediction unit 216 and the intra prediction processing is terminated. This processing is similar to the processing in steps S191 to S203 in FIG. 19 and thus description is omitted.

Note that, in step S236, the prediction unit 216 determines whether the prediction mode is the substitute intra prediction mode or the normal intra prediction mode on the basis of the value of constrained_intra_pred_direction_flag read from the coded stream. Furthermore, in step S237, the prediction unit 216 determines whether or not to apply the substitute intra prediction on the basis of the application condition shared in advance with the image encoding device 11.

Whether to perform the substitute intra prediction or the normal intra prediction is determined even in the image decoding device 201 on the basis of constrained_intra_pred_direction_flag and the application condition in this way, and the prediction image is generated according to the determination result. By doing so, more appropriate prediction between the substitute intra prediction and the normal intra prediction can be applied to each PU to be processed, and a high-quality prediction image can be promptly obtained while permitting a certain degree of stall.

### First Modification of Second Embodiment

### <Application of Substitute Intra Prediction>

Note that, in the above description, an example of determining whether or not to apply the substitute intra prediction according to constrained_intra_pred_direction_flag has been described. However, it is also possible to provide an application range of the substitute intra prediction.

In such a case, it is only required to determine whether or not to perform the substitute intra prediction using constrained_intra_pred_direction_level indicating the application range of the substitute intra prediction, in other words, an application condition, instead of constrained_intra_pred_direction_flag.

Here, constrained_intra_pred_direction_level is a level value indicating an application condition to perform the substitute intra prediction in a current block. In other words, constrained_intra_pred_direction_level is a level value indicating an application condition of the substitute intra prediction. Application conditions different from one another are associated with a plurality of level values, and the value of constrained_intra_pred_direction_level is any of the plurality of level values.

For example, the application condition indicated by the level value is a condition or the like determined according to at least any one of the size of the current block, the processing order (CU number or PU number) of the current block, or the intra prediction mode in the current block.

Such constrained_intra_pred_direction_level is stored in SPS or PPS in the coded stream as information regarding an application condition of the substitute intra prediction, and constrained_intra_pred_direction_level is shared by the image encoding device 11 and the image decoding device 201. Then, in the image encoding device 11 or the image decoding device 201, the substitute intra prediction and the normal intra prediction is switched according to constrained_intra_pred_direction_level.

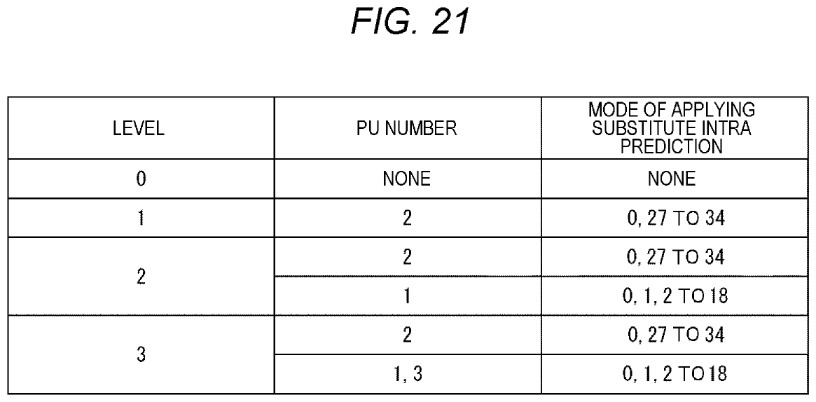

Specifically, for example, in the case of applying the present technology to HEVC as an example, the level value indicated by constrained_intra_pred_direction_level can be set to any of “0” to “3” as illustrated in FIG. 21.

Note that, in FIG. 21, it is assumed that the CU to be processed is 8 pixels×8 pixels, and the PU in the CU is 4 pixels×4 pixels. However, the example illustrated in FIG. 21 may be applied when the CU is 16 pixels×16 pixels or larger, or the level value may be further subdivided and the CU size may be added to the application condition.

In the example illustrated in FIG. 21, the substitute intra prediction is not performed and the normal intra prediction is performed in the case where the level value is 0. That is, in the case of constrained_intra_pred_direction_level=0, this case corresponds to the above-described case of constrained_intra_pred_direction_flag=0.

In the case where the level value is 1, the substitute intra prediction is applied to a PU in which the PU number is 2 and the mode number of the intra prediction mode is any one of 0 and 27 to 34, and the normal intra prediction is applied to PUs other than the aforementioned PU.

Furthermore, in the case where the level value is 2, the substitute intra prediction is applied to a PU in which the PU number is 2 and the mode number of the intra prediction mode is any one of 0 and 27 to 34, and a PU in which the PU number is 1 and the mode number of the intra prediction mode is any one of 0, 1, and 2 to 18. The normal intra prediction is applied to PUs other than the aforementioned PUs.

Moreover, in the case where the level value is 3, the substitute intra prediction is applied to a PU in which the PU number is 2 and the mode number of the intra prediction mode is any one of 0 and 27 to 34, and a PU in which the PU number is 1 or 3 and the mode number of the intra prediction mode is any one of 0, 1, and 2 to 18. The normal intra prediction is applied to PUs other than the aforementioned PUs.

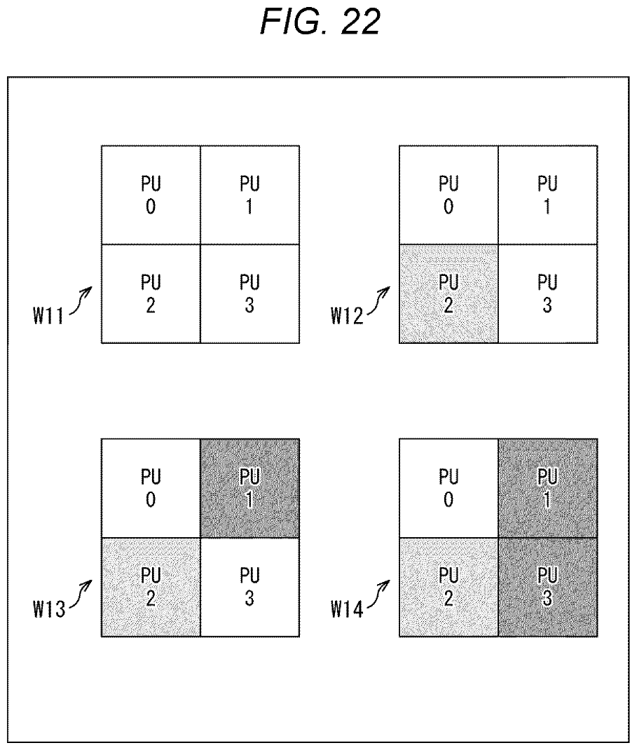

The relationship between each level value of constrained_intra_pred_direction_level and the PU to which the substitute intra prediction is applied illustrated in FIG. 21 is illustrated in FIG. 22, for example.

Note that, in FIG. 22, each quadrangle represents a PU, and the number in the quadrangle indicates the PU number. Furthermore, the density of each PU indicates the intensity of application of the substitute intra prediction. The darker the density, the larger the conditions to apply the substitute intra prediction, in other words, the larger the number of intra prediction modes to apply the substitute intra prediction.

For example, as illustrated with the arrow W11, when the level value is 0, the substitute intra prediction is not applied to any of PU0 to PU3 and the normal intra prediction is performed in the PUs.

Furthermore, as illustrated with the arrow W12, when the level value is 1, the substitute intra prediction is applied to the PU2 in a case where the PU2 satisfies a predetermined condition, in other words, the PU2 is processed by a predetermined intra prediction mode. In contrast, in the case where the level value is 1, the substitute intra prediction is not applied to the PU0, PU1, and PU3.

As illustrated with the arrow W13, in the case where the level value is 2, the substitute intra prediction is applied to the PU2 when the PU2 satisfies the predetermined condition, similarly to when the level value is 1, and the substitute intra prediction is applied to the PU1 when the PU1 satisfies a predetermined condition. In particular, in this example, as illustrated in FIG. 21, the number of intra prediction modes to apply the substitute intra prediction is larger in the PU1 than the PU2. In the case where the level value is 2, the substitute intra prediction is not applied to the PU0 and PU3.

Moreover, as illustrated with the arrow W14, in the case where the level value is 3, the substitute intra prediction is applied to the PU2 when the PU2 satisfies the predetermined condition, similarly to when the level value is 1, and the substitute intra prediction is applied to the PU1 and PU3 when the PU1 and PU3 satisfy a predetermined condition. In particular, in this example, as illustrated in FIG. 21, the number of intra prediction modes to apply the substitute intra prediction is larger in the PU1 or PU3 than the PU2. In the case where the level value is 3, the substitute intra prediction is not applied to the PU0.

The intra prediction mode of performing the substitute intra prediction is determined for each PU for each level value, as described above, whereby more appropriate prediction between the substitute intra prediction and the normal intra prediction can be applied, and a high-quality prediction image can be promptly obtained.

Note that the application condition for each PU can be appropriately determined according to the position of the PU determined according to the PU number in the CU, in other words, the processing order of the PU, and the mode number of the intra prediction mode, in other words, the reference direction in the intra prediction mode.

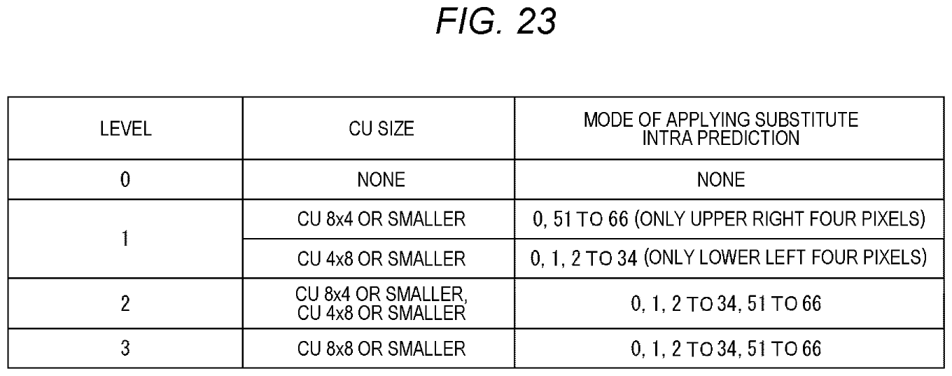

Furthermore, for example, in the case of applying the present technology to FVC (JEM4), the level value indicated by constrained_intra_pred_direction_level can be set to any of “0” to “3” as illustrated in FIG. 23.

The example in FIG. 23 illustrates the application condition determined according to the size of the CU to be processed and the intra prediction mode, for each level value of constrained_intra_pred_direction_level.

In other words, in the case where the level value is 0, for example, the substitute intra prediction is not performed and the normal intra prediction is performed.

In the case where the level value is 1, the substitute intra prediction is applied to a CU in which the CU size is 8 pixels×4 pixels or smaller, and the mode number of the intra prediction mode is any of 0, and 51 to 66. Note that, in this case, the adjacent pixels to which the substitute intra prediction is applied are only four pixels located at the upper right of a CU, which satisfy the application condition.

Furthermore, in the case where the level value is 1, the substitute intra prediction is applied to a CU in which the CU size is 4 pixels×8 pixels or smaller, and the mode number of the intra prediction mode is any of 0, 1, and 2 to 34. In this case, the adjacent pixels to which the substitute intra prediction is applied are only four pixels located at the lower left of a CU, which satisfy the application condition.

In the case where the level value is 2, the substitute intra prediction is applied to CUs in which the CU size is 4 pixels×8 pixels or smaller, or 8 pixels×4 pixels or smaller, and the mode number of the intra prediction mode is any of 0, 1, 2 to 34, and 51 to 66. Then, the normal intra prediction is applied to CUs other than the aforementioned CUs.

Moreover, in the case where the level value is 3, the substitute intra prediction is applied to a CU in which the CU size is 8 pixels×8 pixels or smaller, and the mode number of the intra prediction mode is any of 0, 1, 2 to 34, and 51 to 66, and the normal intra prediction is applied to CUs other than the aforementioned CUs.

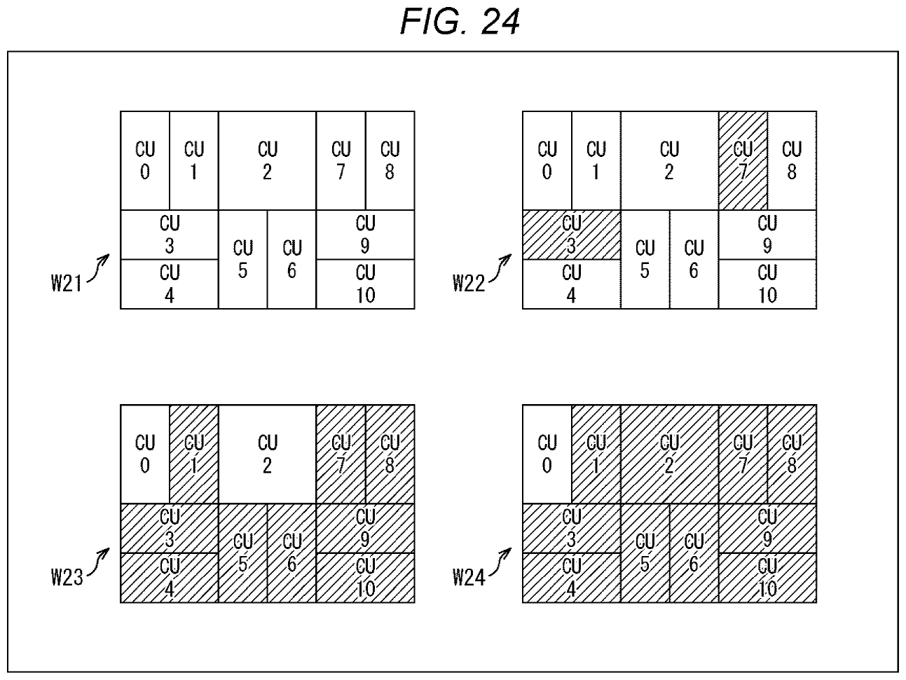

The relationship between each level value of constrained_intra_pred_direction_level and the CU to which the substitute intra prediction is applied illustrated in FIG. 23 is illustrated in FIG. 24, for example.

Note that, in FIG. 24, each quadrangle represents a CU, and the number in the quadrangle indicates the CU number, in other words, the processing order of the CU. Furthermore, the hatched CUs represents the CUs to which the substitute intra prediction is applicable.

For example, as illustrated with the arrow W21, when the level value is 0, the substitute intra prediction is not applied to any of CU0 to CU10 and the normal intra prediction is performed in the CUs.

Furthermore, as illustrated with the arrow W22, when the level value is 1, the substitute intra prediction can be applied to the CU3 and CU7. In other words, the substitute intra prediction is applied to the CUs in a case where the CUs satisfy a predetermined condition, in other words, the CUs are processed by a predetermined intra prediction mode.

As illustrated with the arrow W23, in the case where the level value is 2, the substitute intra prediction is applied to the CU1, and CU3 to CU10. Furthermore, as illustrated with the arrow W24, in the case where the level value is 3, the substitute intra prediction is applied to the CU1 to CU10.

A combination of the size of the CU and the intra prediction mode of performing the substitute intra prediction is determined for each level value as the application condition, as described above, whereby more appropriate prediction between the substitute intra prediction and the normal intra prediction can be applied, and a high-quality prediction image can be promptly obtained. In this case, the application condition of the substitute intra prediction can be appropriately determined according to the size of the CU and the position of the CU determined according to the CU number, in other words, the processing order of the CU, and the mode number of the intra prediction mode, in other words, the reference direction in the intra prediction mode.

As information indicating the application condition as described above, constrained_intra_pred_direction_level may be used. Even in such a case, the control unit 21 of the image encoding device 11 sets constrained_intra_pred_direction_level on the basis of the magnitude of the frame (picture) of the moving image to be encoded, in other words, the size of the picture, high and low of the frame rate of the moving image, high and low of the bit rate of the moving image, or the like.

Therefore, for example, in step S11 in FIG. 11, the control unit 21 sets constrained_intra_pred_direction_level as the encoding parameter, and in step S22, the encoding unit 25 stores constrained_intra_pred_direction_level in the coded stream. In other words, the encoding unit 25 encodes constrained_intra_pred_direction_level.

Furthermore, in step S13 in FIG. 11, the intra prediction processing described with reference to FIG. 19 is performed but the processing in step S196 in FIG. 19 is not performed. In step S197, the determination as to whether or not satisfying the application condition is performed on the basis of the level value indicated by constrained_intra_pred_direction_level acquired in step S191.

For example, in the determination processing as to whether satisfying the application condition, whether or not satisfying the application condition indicated by the level value, in other words, whether or not to apply the substitute intra prediction is determined on the basis of the PU number of the PU to be processed and the intra prediction mode as illustrated in FIG. 21. Therefore, in the case where the PU to be processed as a current block satisfies the application condition indicated by constrained_intra_pred_direction_level (level value), the prediction pixel is generated by the substitute intra prediction in the PU to be processed.

Moreover, the image decoding device 201 performs the image decoding processing described with reference to FIG. 14. At that time, in step S91, the decoding unit 211 also reads constrained_intra_pred_direction_level from the coded stream and supplies constrained_intra_pred_direction_level to the prediction unit 216. In other words, the decoding unit 211 decodes constrained_intra_pred_direction_level.

Furthermore, in step S96, the intra prediction processing illustrated in FIG. 20 is performed but the processing in step S236 in FIG. 20 is not performed. In step S237, determination as to whether satisfying the application condition is performed on the basis of the level value indicated by constrained_intra_pred_direction_level acquired in step S231.

More appropriate prediction between the substitute intra prediction and the normal intra prediction can be applied by applying the substitute intra prediction to the block that satisfies the application condition according to the level value indicated by constrained_intra_pred_direction_level, as described above. Thereby, a high-quality prediction image can be promptly obtained while permitting a certain degree of stall.

### Second Modification of Second Embodiment

### <Application of Substitute Intra Prediction>

Moreover, it is conceivable to impose a constraint on the range of the value (level value) of constrained_intra_pred_direction_level in relation to a level of profile/level of an image defined by a standard such as HEVC or FVC (JEM4).

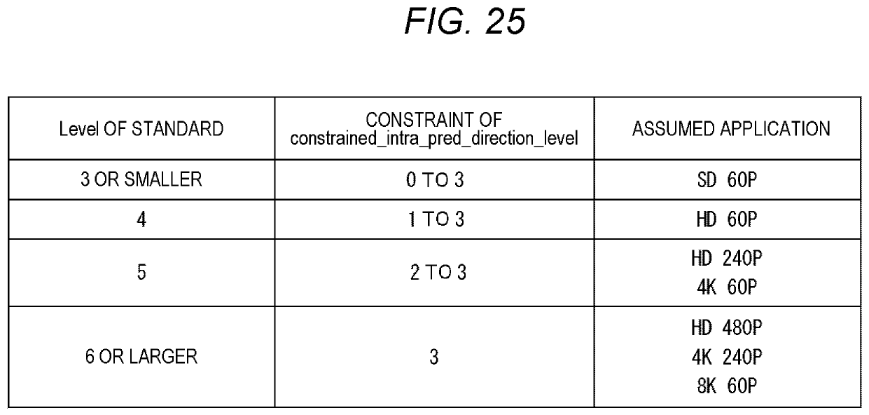

In such a case, constraints are imposed on the levels of the profile/level as illustrated in FIG. 25, for example.

Note that the column “assumed application” in FIG. 25 indicates processing capability (performance) of the image encoding device 11 and the image decoding device 201 assumed for the level of the profile/level. In other words, the column indicates the processing capability required for the image encoding device 11 and the image decoding device 201.

For example, when the level of the profile/level is 3 or smaller, the image encoding device 11 and the image decoding device 201 are assumed to have the processing capability of capable of processing a moving image with the image size of standard definition (SD) and the frame rate of 60 P in real time.

The level of the profile/level of an image is determined on the basis of information regarding a moving image to be encoded, such as the frame size (resolution of picture), frame rate, or bit rate of the moving image, and is stored in SPS or the like of a coded stream, for example.

In the example illustrated in FIG. 25, when the level of the profile/level is 3 or smaller, the above-described level value of constrained_intra_pred_direction_level is set to any of 0 to 3 in the image encoding device 11.

Furthermore, when the level of the profile/level is 4, the level value of constrained_intra_pred_direction_level is set to any of 1 to 3 in the image encoding device 11.

Similarly, when the level of the profile/level is 5, the level value of constrained_intra_pred_direction_level is set to 2 or 3 in the image encoding device 11.

Moreover, when the level of the profile/level is 6 or larger, the level value of constrained_intra_pred_direction_level is set to 3 in the image encoding device 11.

Note that the image encoding device 11 is only required to determine the level value of constrained_intra_pred_direction_level within the constraints illustrated in FIG. 25 on the basis of the information regarding a moving image such as the frame size, frame rate, or bit rate of the moving image to be encoded, and the processing capability (processing performance) that the image encoding device 11 has, in other words, resources.

The higher the level of the profile/level, the higher the required performance for a device for processing a moving image and the smaller the resource margin from the viewpoint of performance. Therefore, the substitute intra prediction is actively utilized in the example illustrated in FIG. 25, thereby easing implementation difficulty.

Specifically, assuming that there is the image encoding device 11 having the processing capability of capable of processing a moving image with the frame size of 8 K and the frame rate of 60 P, for example.

In this case, when the image encoding device 11 encodes the moving image with the frame size of 8 K and the frame rate of 60 P, the performance becomes severe, in other words, the resource margin becomes insufficient. Therefore, an operation to set the level value of constrained_intra_pred_direction_level to 3 is performed.

In contrast, in a case where the image encoding device 11 encodes a moving image with the frame size (resolution) lower than 8 K, a margin occurs in the performance (resource). Therefore, the image encoding device 11 becomes able to perform operation to set the level value of constrained_intra_pred_direction_level to 1 or 2, which is smaller than 3.

As for the frame rate, similarly to the frame size (resolution), the performance is severe with a high frame rate such as 240 P or 480 P of high definition (HD). Therefore, the operation to set the level value of constrained_intra_pred_direction_level to 2 or 3 is performed.

In contrast, when a margin occurs in the performance such as when the frame rate is HD 60 P, the operation to set the level value of constrained_intra_pred_direction_level to 1 is performed.

In the case where the determination of constrained_intra_pred_direction_level is constrained by the level of the profile/level that is the information regarding a moving image to be encoded in the image encoding device 11, setting of the level value of constrained_intra_pred_direction_level is performed in step S11 in FIG. 11.

In other words, in step S11, for example, the control unit 21 determines the level value of constrained_intra_pred_direction_level according to the constraints illustrated in FIG. 25 on the basis of the level of the profile/level of the moving image to be encoded, the processing capability (resources) of the image encoding device 11, and the information regarding a moving image such as the frame size of the moving image to be encoded. In other words, constrained_intra_pred_direction_level is generated.

Then, in step S22, the encoding unit 25 stores constrained_intra_pred_direction_level supplied from the control unit 21 in the coded stream. In other words, the encoding unit 25 encodes constrained_intra_pred_direction_level.

By doing so, more appropriate prediction between the substitute intra prediction and the normal intra prediction can be applied to the block (PU or CU) to be encoded. Thereby, a high-quality prediction image can be promptly obtained while permitting a certain degree of stall.

As described above, according to the present technology, when a pixel of a block processed immediately before a current block to be processed is used as an adjacent pixel for prediction of a pixel of the current block, a pixel value of another pixel is used as a pixel value of the adjacent pixel, whereby a prediction pixel can be more easily and promptly obtained at a lower cost. In particular, reference to an adjacent pixel of the previously processed block is substantially eliminated, whereby the difficulty and implementation cost of parallelization can be reduced, and the scale of a circuit for intra prediction can be reduced and a clock frequency can be made lower.

Furthermore, the present technology described above can be applied to various electronic devices and systems such as, for example, servers, network systems, televisions, personal computers, portable telephones, recording and reproducing devices, imaging devices, and portable devices. Note that the above-described embodiments can be combined as appropriate.

### <Configuration Example of Computer>

By the way, the above-described series of processing can be executed by hardware or software. In the case of executing the series of processing by software, a program that configures the software is installed in a computer. Here, examples of the computer include a computer incorporated in dedicated hardware, and a general-purpose computer or the like capable of executing various functions by installing various programs, for example.

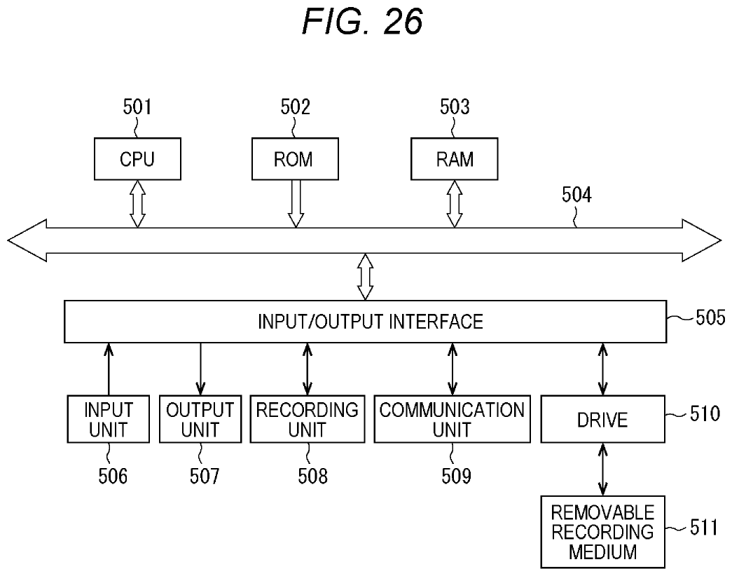

FIG. 26 is a block diagram illustrating a configuration example of hardware of a computer that executes the above-described series of processing by a program.

In a computer, a central processing unit (CPU) 501, a read only memory (ROM) 502, and a random access memory (RAM) 503 are mutually connected by a bus 504.

Moreover, an input/output interface 505 is connected to the bus 504. An input unit 506, an output unit 507, a recording unit 508, a communication unit 509, and a drive 510 are connected to the input/output interface 505.

The input unit 506 includes a keyboard, a mouse, a microphone, an imaging element, and the like. The output unit 507 includes a display, a speaker array, and the like. The recording unit 508 includes a hard disk, a nonvolatile memory, and the like. The communication unit 509 includes a network interface and the like. The drive 510 drives a removable recording medium 511 such as a magnetic disk, an optical disk, a magneto-optical disk, or a semiconductor memory.

In the computer configured as described above, the CPU 501 loads a program recorded in the recording unit 508 into the RAM 503, for example, and executes the program via the input/output interface 505 and the bus 504, thereby performing the above-described series of processing.

The program to be executed by the computer (CPU 501) can be recorded on the removable recording medium 511 as a package medium or the like, for example, and provided. Furthermore, the program can be provided via a wired or wireless transmission medium such as a local area network, the Internet, or digital satellite broadcast.

In the computer, the program can be installed to the recording unit 508 via the input/output interface 505 by attaching the removable recording medium 511 to the drive 510. Furthermore, the program can be received by the communication unit 509 via a wired or wireless transmission medium and installed in the recording unit 508. Other than the above method, the program can be installed in the ROM 502 or the recording unit 508 in advance.

Note that the program executed by the computer may be a program processed in chronological order according to the order described in the present specification or may be a program executed in parallel or at necessary timing such as when a call is made.

Furthermore, embodiments of the present technology are not limited to the above-described embodiments, and various modifications can be made without departing from the gist of the present technology.

For example, in the present technology, a configuration of cloud computing in which one function is shared and processed in cooperation by a plurality of devices via a network can be adopted.

Furthermore, the steps described in the above-described flowcharts can be executed by one device or can be shared and executed by a plurality of devices.

Moreover, in the case where a plurality of processes is included in one step, the plurality of processes included in the one step can be executed by one device or can be shared and executed by a plurality of devices.

Furthermore, the effects described in the present specification are merely examples and are not limited, and other effects may be exhibited.

Furthermore, the present technology may be configured as follows.

(1)

An image processing device including:

a prediction unit configured to generate, in a case of generating a prediction pixel of a current block of an image to be processed by intra prediction, in a case where a pixel in a previous block previous to the current block in a processing order is an adjacent pixel to be used for generating the prediction pixel, the prediction pixel using a pixel value of another adjacent pixel in another block different from the previous block as a pixel value of the adjacent pixel in the previous block.

(2)

The image processing device according to (1), in which

the another adjacent pixel is a pixel adjacent to the previous block.

(3)

The image processing device according to (1) or (2), in which

the processing order is predetermined.

(4)

The image processing device according to any one of (1) to (3), in which

the prediction unit generates the prediction pixel by substitute intra prediction that is intra prediction for generating the prediction pixel using the pixel value of the another adjacent pixel as the pixel value of the adjacent pixel according to application information regarding application of the substitute intra prediction.

(5)

The image processing device according to (4), in which

the application information is flag information indicating whether or not to perform the substitute intra prediction.

(6)

The image processing device according to (5), in which

the prediction unit generates the prediction pixel by the substitute intra prediction in a case where the application information is a value indicating to perform the substitute intra prediction, and the current block satisfies a predetermined condition.

(7)

The image processing device according to (6), in which

the predetermined condition is a condition determined according to at least one of a size of the current block, a processing order of the current block, or an intra prediction mode of the current block.

(8)

The image processing device according to (4), in which

the application information is information indicating an application condition in which the substitute intra prediction is performed in the current block.

(9)

The image processing device according to (8), in which

the application condition is a condition determined according to at least one of a size of the current block, a processing order of the current block, or an intra prediction mode of the current block.

(10)

The image processing device according to (8) or (9), in which

the application information is information indicating any of a plurality of the application conditions different from one another, and

the prediction unit generates the prediction pixel by the substitute intra prediction in a case where the current block satisfies the application condition indicated by the application information.

(11)

The image processing device according to any one of (4) to (10), in which

the application information is generated on the basis of information regarding the image.

(12)

The image processing device according to (11), in which

the information regarding the image is a frame size, a frame rate, or a bit rate of the image.

(13)

The image processing device according to (11), in which

the information regarding the image is a level of profile/level of the image.

(14)

The image processing device according to any one of (4) to (13), further including:

an encoding unit configured to encode the application information.

(15)

The image processing device according to any one of (4) to (13), further including:

a decoding unit configured to decode the application information.

(16)

An image processing method including a step of:

generating, in a case of generating a prediction pixel of a current block of an image to be processed by intra prediction, in a case where a pixel in a previous block previous to the current block in a processing order is an adjacent pixel to be used for generating the prediction pixel, the prediction pixel using a pixel value of another adjacent pixel in another block different from the previous block as a pixel value of the adjacent pixel in the previous block.

(17)

A program for causing a computer to execute processing including a step of:

generating, in a case of generating a prediction pixel of a current block of an image to be processed by intra prediction, in a case where a pixel in a previous block previous to the current block in a processing order is an adjacent pixel to be used for generating the prediction pixel, the prediction pixel using a pixel value of another adjacent pixel in another block different from the previous block as a pixel value of the adjacent pixel in the previous block.

### REFERENCE SIGNS LIST

11 Image encoding device
21 Control unit
25 Encoding unit
30 Prediction unit
201 Image decoding device
211 Decoding unit
216 Prediction unit

1. An image processing device comprising:
a prediction unit configured to generate, in a case of generating a prediction pixel of a current block of an image to be processed by intra prediction, in a case where a pixel in a previous block previous to the current block in a processing order is an adjacent pixel to be used for generating the prediction pixel, the prediction pixel using a pixel value of another adjacent pixel in another block different from the previous block as a pixel value of the adjacent pixel in the previous block.

2. The image processing device according to claim 1, wherein
the another adjacent pixel is a pixel adjacent to the previous block.

3. The image processing device according to claim 1, wherein
the processing order is predetermined.

4. The image processing device according to claim 1, wherein
the prediction unit generates the prediction pixel by substitute intra prediction that is intra prediction for generating the prediction pixel using the pixel value of the another adjacent pixel as the pixel value of the adjacent pixel according to application information regarding application of the substitute intra prediction.

5. The image processing device according to claim 4, wherein
the application information is flag information indicating whether or not to perform the substitute intra prediction.

6. The image processing device according to claim 5, wherein
the prediction unit generates the prediction pixel by the substitute intra prediction in a case where the application information is a value indicating to perform the substitute intra prediction, and the current block satisfies a predetermined condition.

7. The image processing device according to claim 6, wherein
the predetermined condition is a condition determined according to at least one of a size of the current block, a processing order of the current block, or an intra prediction mode of the current block.

8. The image processing device according to claim 4, wherein
the application information is information indicating an application condition in which the substitute intra prediction is performed in the current block.

9. The image processing device according to claim 8, wherein
the application condition is a condition determined according to at least one of a size of the current block, a processing order of the current block, or an intra prediction mode of the current block.

10. The image processing device according to claim 8, wherein
the application information is information indicating any of a plurality of the application conditions different from one another, and
the prediction unit generates the prediction pixel by the substitute intra prediction in a case where the current block satisfies the application condition indicated by the application information.

11. The image processing device according to claim 4, wherein
the application information is generated on a basis of information regarding the image.

12. The image processing device according to claim 11, wherein
the information regarding the image is a frame size, a frame rate, or a bit rate of the image.

13. The image processing device according to claim 11, wherein
the information regarding the image is a level of profile/level of the image.

14. The image processing device according to claim 4, further comprising:
an encoding unit configured to encode the application information.

15. The image processing device according to claim 4, further comprising:
a decoding unit configured to decode the application information.

16. An image processing method comprising a step of:
generating, in a case of generating a prediction pixel of a current block of an image to be processed by intra prediction, in a case where a pixel in a previous block previous to the current block in a processing order is an adjacent pixel to be used for generating the prediction pixel, the prediction pixel using a pixel value of another adjacent pixel in another block different from the previous block as a pixel value of the adjacent pixel in the previous block.

17. A program for causing a computer to execute processing comprising a step of:
generating, in a case of generating a prediction pixel of a current block of an image to be processed by intra prediction, in a case where a pixel in a previous block previous to the current block in a processing order is an adjacent pixel to be used for generating the prediction pixel, the prediction pixel using a pixel value of another adjacent pixel in another block different from the previous block as a pixel value of the adjacent pixel in the previous block.
